(19) United States
(12) Patent Application Publication
(10) Pub. No.: US 2010/0081011 A1
(43) Pub. Date: Apr. 1, 2010

(54) MAGNETIC RECORDING MEDIUM

(75) Inventor: Kenichi NAKAMURA, Odawara-shi (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/569,071

(22) Filed: Sep. 29, 2009

(30) Foreign Application Priority Data
Sep. 29, 2008 (JP) 2008-251799

(51) Int. Cl. G11B 5/68

(52) U.S. Cl. 428/832

(57) ABSTRACT

A magnetic recording medium includes, in the following order: a backcoat layer; a nonmagnetic support; a nonmagnetic layer containing a nonmagnetic powder and a binder; and a magnetic layer containing a ferromagnetic powder and a binder, wherein the backcoat layer contains particles having an average primary particle size D50 of from 0.05 to 1.0 μm and forming substantially no aggregates nor agglomerates in the backcoat layer.

### CROSS-REFERENCE TO RELATED APPLICATIONS

This application claims the benefit of Japanese Patent Application JP 2008-251799, filed Sep. 29, 2008, the entire content of which is hereby incorporated by reference, the same as if set forth at length.

### FIELD OF THE INVENTION

This invention relates to a magnetic recording medium that exhibits good running stability and improved electromagnetic conversion characteristics by preventing the surface profile of the backcoat layer from being imprinted on the magnetic layer to form depressions, that would cause dropouts, an increase in error rate, and a reduction in S/N.

### BACKGROUND OF THE INVENTION

Magnetic recording media are widely used in the form of magnetic tape, such as sound recording tapes and videotapes, and magnetic disk, such as flexible disks. Prevailing magnetic tapes are those including a nonmagnetic support, e.g., of PET or PEN, a magnetic layer formed by magnetic coating application or metal evaporation on one side of the support, and a backcoat layer on the other side of the support. The backcoat layer is made of a binder resin having dispersed therein nonmagnetic particles containing carbon black and usually has a rough surface due to the carbon black particles. The surface roughness of the backcoat layer is effective in improving running stability by adjusting the coefficient of friction with parts that come into contact during tape manufacture and with drive systems and by preventing winding error caused by entrainment of air during tape winding.

Backcoated magnetic tapes include audio or video tapes and computer backup tapes. High-capacity data backup tapes have been commercialized to handle the ever diversifying and increasing information.

Techniques to increase the recording capacity of magnetic tapes include (a) increasing the recording density per unit area by using shorter recording wavelengths or reducing the track width and (b) reducing the tape thickness thereby to increase the tape length per pack.

When the method (a) is taken, it is necessary to reduce the space between the magnetic layer and a magnetic head because the leakage magnetic flux emanating from the magnetic recording medium reduces. If a magnetic layer has large protrusions or depressions on its surface, the output will reduce due to the spacing loss, which can cause dropouts, increase in error rate, and reduction in S/N. In order to prevent such output reduction, the magnetic layer of a high-capacity data backup tape should have a very smooth surface.

However, because a magnetic tape is usually wound on a core, a cassette hub, or the like into a pancake, the magnetic layer and the backcoat layer are kept in contact with each other during tape manufacture, aging (e.g., heat treatment), and storage. In the meanwhile the surface profile of the backcoat layer is transferred (imprinted) onto the magnetic layer surface, resulting in roughening the surface of the magnetic layer. This phenomenon will hereinafter be referred to as back imprinting. The imprinted surface roughness of the magnetic layer causes spacing loss, leading to output reduction, and resulting in increases in dropout and error rate and reduction in S/N.

If the backcoat layer is provided with a smooth surface in an attempt to prevent the back imprinting phenomenon, the coefficient of friction between the backcoat layer and parts coming into contact during tape manufacture and with a drive system would increase, and winding error due to air entrainment during winding would occur. As a result, running stability of the tape would be deteriorated.

Proposals have hitherto been made in order to prevent back imprinting to improve electromagnetic characteristics without impairing running stability. For example, JP 2-7223A, JP 2-141925A, JP 9-270115A, JP 9-115134A, JP 2006-155695A and JP 4-81256B propose incorporating at least two kinds of carbon blacks different in average particle size in a backcoat layer.

The method (b) is implemented by reducing the thickness of the nonmagnetic support or coating layers including a backcoat layer, a magnetic layer, and a nonmagnetic layer. For example, JP 2005-222644A proposes a backcoat layer that is relatively thin and yet hardly imprints its surface roughness on the magnetic layer.

It is difficult, nevertheless, to provide a magnetic recording medium having a further increased capacity with improved running stability as well as improved electromagnetic characteristics by preventing back imprinting. The difficulty is attributed to the structure of carbon black making the surface of a backcoat layer rough. That is, carbon black particles tend to form aggregates or agglomerates in a backcoat layer, which appear as large and high protrusions on the surface of the backcoat layer. The protrusions are to be imprinted on the magnetic layer side to form large and deep depressions on the surface of the magnetic layer.

### SUMMARY OF THE INVENTION

In the light of the above circumstances, an object of the present invention is to provide a magnetic recording medium exhibiting good running stability as well as improved electromagnetic characteristics by reducing imprinted depressions on its magnetic layer that cause increases in dropout and error rate and reduction in S/N.

The object of the invention is accomplished by the provision of a magnetic recording medium including a nonmagnetic support, a nonmagnetic layer containing a nonmagnetic powder and a binder on one side of the support, a magnetic layer containing a ferromagnetic powder and a binder on the nonmagnetic layer, and a backcoat layer on the other side of the support. The backcoat layer contains particles having an average primary particle size (D50) of 0.05 to 1.0 μm and forming substantially no aggregates nor agglomerates in the backcoat layer.

The invention includes the following preferred embodiments of the magnetic recording medium in which:

(1) The particles have an average primary particle size (D50) of 0.1 to 0.6 μm.
(2) The backcoat layer contains spherical particles having a particle size distribution D25/D75 of 2.0 or smaller, more preferably 1.5 or smaller.
(3) The particles have its particle size distribution D25/D75 adjusted to 2.0 or smaller by classification.
(4) The particles are polymer particles having a crosslinked structure.
(5) The particles are polymer particles containing at least one component selected from the group consisting of an acrylic compound, styrene, divinylbenzene, benzoguanamine, melamine, formaldehyde, butadiene, acrylonitrile, and chloroprene.
(6) The particles are thermoplastic and have a glass transition temperature or a softening temperature of 20° to 160° C.
(7) The particles are polymer particles obtained by a seed emulsion polymerization technique in which a crosslinkable or polymerizable monomer is added to an aqueous dispersion of seed particles, absorbed by the seed particles, and allowed to polymerize.
(8) The particles are inorganic particles made mainly of silicon dioxide.
(9) The backcoat layer does not contain carbon black having a specific surface area less than 30 m²/g.
(10) The total residual solvent in the magnetic layer, the nonmagnetic layer, and the backcoat layer is 0.1 to 25 mg/g.
(11) The magnetic recording medium has a lower indentation hardness on the side of the backcoat layer than on the side of the magnetic layer.
(12) The nonmagnetic support is a support made mainly of an aromatic polyamide or a support having a nonmagnetic film of a metal or a metallic inorganic compound formed on at least one side thereof by vapor deposition.

According to the invention, the backcoat layer has protrusions necessary to secure running stability on its surface and yet hardly imprints the magnetic layer with depressions than can invite increases in dropout and error rate and decrease in S/N even when the magnetic recording medium is subjected to aging (e.g., heat treatment) or storage in the form of tape roll or pancake around a core or a hub. Thus, there is provided a magnetic recording medium excellent in running stability as well as electromagnetic conversion characteristics.

### BRIEF DESCRIPTION OF THE DRAWING

The Drawing is an SEM image of polymer particles Y-1 prepared in Example 3-1.

### DETAILED DESCRIPTION OP THE INVENTION

The magnetic recording medium of the invention includes a nonmagnetic support, a nonmagnetic layer containing a nonmagnetic powder and a binder on one side of the support, a magnetic layer containing a ferromagnetic powder and a binder on the nonmagnetic layer, and a backcoat layer on the other side of the support.

The magnetic recording medium preferably has a thickness of 10 μm or less, more preferably 8 μm or less, even more preferably 7 μm or less.

The backcoat layer used in the invention contains at least one kind of particles having an average primary particle size D50 of 0.05 to 1.0 μm and not being substantially in the form of aggregate (a mass or body formed by, for example, the fusion of a plurality of primary particles) nor agglomerate.

As used herein, the term “average primary particle size D50” denotes a diameter corresponding to 50% of the volume of all the particles cumulated from the largest particles.

The expression “not being substantially in the form of aggregate nor agglomerate (forming substantially no aggregates nor agglomerates)” means that out of 100 specimens in the backcoat layer two or fewer are aggregates or agglomerates as observed on the surface and cross-section of the backcoat layer using a scanning electron microscope (SEM). In this regard, primary particle (including aggregate) and agglomerate are considered as minimum units so that each of one primary particle (including aggregate) and one agglomerate is counted as one specimen.

The particles existing in the form of primary particle without forming an aggregate or agglomerate in the backcoat layer, they are prevented from forming large protrusions on the surface of the backcoat layer. As a result, the magnetic layer is prevented from forming large depressions due to back imprinting during manufacture, aging (e.g., heat treatment) or storage of the medium in the form of bulk roll or pancake around a core or a hub.

The average primary particle size D50 of the particles in the backcoat layer is preferably 0.1 to 0.7 μm, more preferably 0.1 to 0.6 μm, even more preferably 0.2 to 0.5 μm.

The average primary particle size D50 of the particles is preferably 0.2 to 1.5 times, more preferably 0.3 to 1.3 times, even more preferably 0.5 to 1.2 times, most preferably 0.75 to 1.1 times, the thickness of the backcoat layer.

It is preferred for the particles to have a narrow size distribution. Particles with a broader size distribution has a higher distribution frequency of large primary particles and allows formation of large protrusions on the surface of the backcoat layer that would form large depressions on the surface of the magnetic layer. In this regard, the particles preferably has as small a particle size distribution D25/D75 (where D25 and D75, respectively, are the particle diameter of 25% and 75% of a volume based cumulative particle size distribution curve from the largest particle size) as possible, specifically of 2.0 or smaller, more preferably 1.5 or smaller, even more preferably 1.3 or smaller, most preferably 1.2 or smaller.

The narrower the particle size distribution, the more uniform the protrusions formed on the backcoat layer surface in size and shape. As a result, it is easier to control the coefficient of friction of the backcoat layer with parts that come into contact during tape manufacture and with drive systems, and winding error caused by air entrainment during winding is prevented more effectively, thus providing further improved running stability. Additionally, increase of large depressions on the magnetic layer surface is avoided.

Classifying particles is a preferred means to control the average primary particle size and particle size distribution as desired. Known dry and wet classifying techniques may be used. Wet classification is preferred for effective control of the average primary particle size and particle size distribution.

The particles are preferably amorphous, nearly spherical, or spherical, more preferably nearly spherical or spherical, even more preferably spherical. The particles with the preferred shapes form protrusions very uniform in shape on the backcoat layer surface.

Types of the particles include known polymer particles and inorganic particles. The polymer particles preferably have a crosslinked structure. Because a backcoat layer is usually formed using a coating composition containing a general-purpose organic solvent (such as a ketone solvent, e.g., methyl ethyl ketone, methyl isobutyl ketone or cyclohexanone, an alcohol solvent, e.g., methanol, ethanol or isopropyl alcohol, or toluene), it is preferred that the particles be insoluble in the solvent used in the coating composition.

The polymer particles are preferably of a polymer containing at least one component selected from an acrylic compound, styrene, divinylbenzene, benzoguanamine, melamine, formaldehyde, butadiene, acrylonitrile, chloroprene, and a fluorine-containing compound, more preferably of a polymer containing an acrylic compound, styrene, or divinylbenzene as a component, even more preferably a polymer containing an acrylic compound or styrene as a component. Starting with these preferred components enables easy control of average primary particle size and particle size distribution and easy formation of particles that are less likely to aggregate or agglomerate.

The polymer particles are preferably thermoplastic for the following reason. The surface of the magnetic layer is liable to indentation while the magnetic recording medium in the form of a roll on a core or hub is being heat treated. This is because the nonmagnetic support shrinks due to the heat treatment thereby to increase the pressure of contact between the magnetic layer and the backcoat layer. The thermoplastic polymer particles are able to change in shape when heat treated according to the planar pressure applied between the magnetic layer and the backcoat layer, thereby to lessen the pressure applied by the protrusions of the polymer particles onto the magnetic layer. It follows that the magnetic layer is prevented from forming large depressions as a result of back imprinting.

The thermoplastic polymer polymers preferably have a glass transition temperature (Tg) or softening temperature (Ts) of 20° to 160° C., more preferably 40° to 140° C., even more preferably 50° to 120° C. Even when the polymer particles have a Tg or Ts slightly higher than a heat treatment temperature or a storage temperature of a magnetic recording medium in which they are incorporated, the effect of thermoplasticity in reducing depressions is exerted because the particles will be plasticized and softened at the heat treatment temperature or storage temperature by the action of an additive or residual solvent in the magnetic layer, nonmagnetic layer, and backcoat layer.

If the Tg or Ts of the polymer particles is too much higher than the heat treatment or storage temperature, deformation of the polymer particles under the contact pressure applied between the magnetic layer and the backcoat layer is insufficient to produce the depression reducing effect.

If, on the other hand, the Tg or Ts of the polymer particles is too much lower than the heat treatment or storage temperature, the polymer particles can adhere to the magnetic layer. Such polymer particles also become too soft at temperatures used in drying the magnetic layer, nonmagnetic layer, and backcoat layer and in calendering, which can deteriorate the running properties. For that reason, polymer particles made mainly of silicone are unfavorable because of their low softening temperature.

The particles are preferably those obtained by a seed emulsion polymerization technique in which a crosslinkable or polymerizable monomer is added to an aqueous dispersion of seed particles, adsorbed by the seed particles, and allowed to polymerize. The seed emulsion polymerization stated enables preparation of polymer particles having an average primary particle size D50 of 1.0 μm or less and a very small particle size distribution D25/D75.

For the details of the seed emulsion polymerization method and polymer particles prepared by the method for use in the invention, reference can be made to JP 2005-54108A and JP 2005-281484A.

The preparation of polymer particles involves use of various additives, such as an emulsifying agent (e.g., a surfactant), a polymerization initiator, a chain transfer agent, and a polymerization inhibitor. Not only these additives but by-products produced in the preparation step of the polymer particles (e.g., the uncrosslinked monomer or polymer component) can cause various disadvantages, such as deterioration of electromagnetic characteristics due to transfer of the additives or by-products from the backcoat layer to the magnetic layer. It is therefore advisable to remove the unfavorable matter before the polymer particles are formulated into a coating composition by, for example, washing the polymer particles with water or an organic solvent in which they do not dissolve.

Commercially available polymer particles may be used in the invention, including Chemisnow series (e.g., crosslinked acrylic polymer particles and crosslinked polystyrene particles from Soken Chemical & Engineering Co., Ltd.), Advancell series (e.g., crosslinked acrylic particles, from Sekisui Chemical Co., Ltd.), Eposter series (e.g., melamine-formaldehyde condensate particles, from Nippon Shokubai Co., Ltd.), Liosphere series (e.g., crosslinked acrylic polymer particles, from Toyo Ink Mfg. Co., Ltd.), and Finesphere series (e.g., crosslinked acrylic polymer particles and crosslinked polystyrene particles, from Nippon Paint Co., Ltd.).

Examples of the inorganic particles for use in the backcoat layer of the invention include silicon dioxide (silica), alumina, and zirconia. Silicon dioxide particles are particularly preferred because they are easy to produce with controlled average primary particle size and particle size distribution by a known liquid or vapor phase synthesis method. Alumina and zirconia are also preferred for providing spherical particles by a thermal spraying process known as a vapor phase synthesis method.

Examples of commercially available inorganic particles that may be used in the invention include Seafoster series (e.g., silicon dioxide particles, from Nippon Shokubai Co., Ltd.) and Admafine series (e.g., alumina particles, from Micron Technology, Inc.).

In order to prevent the polymer particles or inorganic particles from taking on the form of aggregate or agglomerate in the backcoat layer, it is necessary to perform an appropriate manipulation in preparing the particles or adding the particles to the backcoat layer.

The particles may be of either a single substance or a mixture of a plurality of substances.

It is possible for the backcoat layer to perform other functions. For example, the backcoat layer may be designed to have electric conductivity (hereinafter simply referred to as conductivity) to prevent dust attraction due to electrification. Carbon black is preferably added to render the backcoat layer conductive. Carbon black, however, is liable to form large protrusions on the backcoat layer surface, which will be imprinted on the magnetic layer to form large depressions, because it usually has a broad particle size distribution and exists in the form of aggregate or agglomerate. Therefore, it is necessary to consider the particle size of the carbon black to be used in the backcoat layer to impart conductivity.

It is preferred that the carbon black for use in the invention have a specific surface area of 30 m²/g or more so as not to form large protrusions in the backcoat layer. To put it another way, it is preferred that the backcoat layer not contain carbon black having a specific surface area less than 30 m²/g. The specific surface area of the carbon black to be used in the backcoat layer is preferably 50 m²/g or more, more preferably 100 m²/g or more, even more preferably 150 m²/g or more. It is necessary to pay attention to the way of adding carbon black even in using carbon black with the preferred specific surface area recited. Carbon black should be added in a manner that minimizes formation of aggregates and agglomerates.

Carbon blacks commonly used in magnetic recording media can be used in the backcoat layer, such as furnace black for rubber, thermal black for rubber, carbon black for colors, and acetylene black. The carbon black to be used preferably has a DBP (dibutyl phthalate) absorption of 60 to 400 ml/100 g, a pH of 2 to 10, a water content of 0.1% to 10%, and a tap density of 0.1 to 1 g/cc.

For the details of carbon blacks useful in the backcoat layer, Carbon Black Binran, edited by Carbon Black Kyokai can be referred to.

Examples of commercially available carbon black products that may be used in the invention include #60, #70, #80, and F200 from Asabi Carbon Co., Ltd.; #2400, #2300, #900, #1000, #30, and #40 from Mitsubishi Chemical Co., Ltd.; N110, N220, N330, IP1000, and IP2000 from Showa Cabot K.K.; and Seast 9, 5H, 6, 3, and 116 from Tokai Carbon Co., Ltd.

Carbon black having been surface treated with a dispersant, etc., resin-grafted carbon black, or carbon black with its surface partially graphitized may be used. Carbon black may previously been dispersed in a binder. The carbon blacks described above can be used either alone or as a combination thereof.

The backcoat layer may further contain fine inorganic particles. The fine inorganic particles preferably have a Mohs hardness of 5 to 9, such as α-iron oxide, α-alumina, chromium oxide (Cr₂O₃), and TiO₂. Alpha-iron oxide and α-alumina are particularly preferred. Addition of such fine inorganic particles brings about improvement of scratch resistance of the backcoat layer. Similarly to the carbon black, it is preferred for the fine inorganic particles not to form large protrusions on the backcoat layer surface, and the way of adding the fine inorganic particles should be chosen appropriately.

The backcoat layer preferably contains a binder in addition to the particles, carbon black, fine inorganic particles, and so on so as to have sufficient coating film strength. The amount of the binder is preferably 40 to 200 parts, more preferably 60 to 180 parts, even more preferably 80 to 160 parts, by mass per 100 parts by mass of the sum of the particles, carbon black, and fine inorganic particles. The binder resin may be chosen from known thermoplastic resins, thermosetting resins, reactive resins, and the like.

The surface roughness of the backcoat layer should be designed such that the running stability of the magnetic recording medium may be improved through the adjustment of friction coefficient with parts during the manufacture or drive systems and prevention of tape winding error due to entrainment of air between adjacent strands of tape during winding and, at the same time, formation of depressions on the magnetic layer surface may be reduced. The centerline average surface roughness (Ra) of the backcoat layer is preferably 3 to 20 nm, more preferably 5 to 25 nm, even more preferably 7 to 20 nm, most preferably 10 to 20 nm.

It is preferred that there be no protrusions of 150 nm or higher on the backcoat layer surface. It is also preferred that the number of protrusions of 100 to 150 nm in height be 1 to 100, more preferably 1 to 50, even more preferably 1 to 25, most preferably up to 15, per 0.1 mm². It is also preferred that there be no protrusions with a circle equivalent diameter of 4 μm or greater, more preferably no protrusions with a circle equivalent diameter of 3 μm or greater, even more preferably no protrusions with a circle equivalent diameter of 2 μm or greater, most preferably no protrusions having a circle equivalent diameter of 1.5 μm or greater. The Ra or the number of protrusions of the backcoat layer can be determined using a known atomic force microscope (AFM).

In a high density magnetic recording tape having a magnetic layer with a very smooth surface particularly on a 6 μm or less thick, dimensionally stable nonmagnetic support (for example, a support made mainly of an aromatic polyamide or a support having a nonmagnetic film of a metal or a metallic inorganic compound formed on at least one side thereof by vapor deposition, as will be described later), controlling the surface profile of the backcoat layer as stated secures excellent running stability and suppresses formation of depressions on the magnetic layer surface due to back imprinting, which cause increases in dropout rate and error rate and a reduction in S/N. Using the aforementioned specific particles allows for such surface profile control.

The magnetic recording medium of the invention preferably has a lower indentation hardness on its backcoat layer side than on the magnetic layer side. The backcoat layer side being softer than the magnetic layer side, the pressure by the protrusions on the backcoat layer surface applied to the magnetic layer side is lessened thereby to reduce depressions on the magnetic layer surface due to back imprinting.

As previously stated, formation of a depression due to back imprinting occurs due to shrinkage of the nonmagnetic support when the magnetic recording medium wound in the form of roll on a core is heat treated or when the tape wound on a reel in a cartridge is stored under a high temperature condition. It is therefore preferred for the magnetic recording medium to have a lower indentation hardness on its backcoat layer side than on the magnetic layer side at the temperature of heat treatment or storage.

The indentation hardness may be measured using known methods of measurement. For example, measurement may be taken using an indenter shown in FIG. 3 of JP 2005-339607A in accordance with the definition illustrated in FIG. 3, ibid. More specifically, a three-sided pyramidal diamond nanoindenter (known as a Berkovich indenter) having a tip radius of 100 nm at the vertex a, a rake angle α of 65°, and an apex angle β of 115° (see FIG. 3 of JP 2005-339607A) is pressed onto the surface of the magnetic layer side or the backcoat layer side to a maximum load of 6 mgf and then removed to depict a load-displacement curve, from which the indentation hardness is obtained. When the above-specified indenter is pressed under a load of 6 mgf, the vertex a of the indenter does not penetrate to a depth of 0.1 μm, allowing for determining indentation hardness characteristics.

A hardness meter equipped with the Berkovich indenter and capable of measurement under a load of 6 mgf is exemplified by a nanoindentation tester ENT-1100a available from Elionix Inc.

FIG. 4 of JP 2005-339607A is a graph showing change in displacement when a sample is loaded by the indenter up to 6 mgf (loading curve A) and then unloaded (unloading curve B). As is seen from the graph, the displacement increases with the load increasing up to the maximum displacement Hmax at 6 mfg. When unloaded, the displacement gradually decreases. The indentation hardness (DH) of the sample is calculated from the maximum displacement (Hmax) and the maximum load (Pmax=6 mgf) according to equation (1):

DH=3.7926×10⁻²{Pmax/(Hmax)²} (kg/mm²)=0.37{Pmax/(Hmax)²} (Mpa) (1)

where Pmax: maximum load; Hmax: maximum displacement

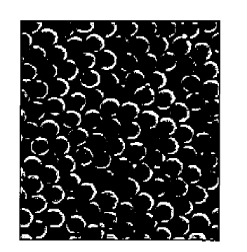

The backcoat layer preferably has a surface resistivity of 1.0×10⁹ Ω/sq (Ω/□) or less, more preferably 1.0×10⁴ to 1.0×10⁸ Ω/sq, even more preferably 1×10⁵ to 1×10⁷ Ω/sq, most preferably 1×10⁵ to 5×10⁶ Ω/sq. The surface resistivity of the backcoat layer may be measured using the electrodes illustrated in FIG. 1 of JP 2008-77698A.

Appropriate control of the surface resistivity of the backcoat layer prevents static electrification of the magnetic recording medium thereby preventing electrostatic adhesion of dust and debris that may cause a dropout. To control the surface resistivity of the backcoat layer to the recited range is preferred because the magnetic recording medium is readily electrified particularly in a dry atmosphere, such as a low temperature low humidity environment.

The thickness of the backcoat layer is preferably 0.1 to 1.0 μm. A thinner layer thickness is desirable to achieve higher capacity of a magnetic recording medium. The thickness is more preferably 0.2 to 0.6 μm, even more preferably 0.2 to 0.5 μm.

The nonmagnetic support used in the invention may be of known materials, such as polyesters (e.g., polyethylene terephthalate and polyethylene naphthalate), polyolefins, cellulose triacetate, polycarbonate, polyamide, polyimide, polyamide-imide, polysulfone, and polybenzoxazole. In particular, polyester supports (e.g., polyethylene terephthalate and polyethylene naphthalate) that are inexpensive and aromatic polyamide (aramid) supports having good heat resistance and dimensional stability are preferred. The nonmagnetic support may have a single layer structure or a laminate structure described in JP 3-224127A.

It is preferred that the support for use in the invention be inexpensive. A polyester support is used for preference from this viewpoint.

The polyester is a polymer obtained by polycondensation between an aromatic dicarboxylic acid, such as terephthalic acid or 2,6-naphthalenedicarboxylic acid, and an aliphatic glycol, such as ethylene glycol, diethylene glycol, or 1,4-cyclohexanedimethanol. The polymer may be either a homopolymer or a copolymer containing a third component. Examples of the dicarboxylic acid component include isophthalic acid, phthalic acid, terephthalic acid, 2,6-naphthalenedicarboxylic acid, adipic acid, sebacic acid, and a hydroxycarboxylic acid (e.g., p-hydroxybenzoic acid). These dicarboxylic acid components may be used either individually or as a combination of two or more thereof. Examples of the glycol component include ethylene glycol, propylene glycol, butanediol, 1,4-cyclohexanedimethanol, neopentyl glycol, diethylene glycol, and triethylene glycol. These glycol components may be used either individually or as a combination of two or more thereof.

Of polyester supports preferred are those made mainly of polyethylene terephthalate (PET) or polyethylene 2,6-naphthalenedicarboxylate (PEN). In using PET or PEN as a main component of a support, a copolymer containing 5 mol % or more of a third component selected form isophthalic acid, terephthalic acid, 2,6-naphthalenedicarboxylic acid, 1,4-cyclohexanedimethanol, 1,4-butanediol, and diethylene glycol based on the total acid or glycol component is also preferred as the main component.

The main component of the nonmagnetic support preferably has a Tg of 100° C. or higher. In this respect, PEN is the most preferred of the polyesters. Preferred examples of nonmagnetic supports having PEN as a main component are given in JP 2005-329458A and JP 2005-330311A.

In order to prevent back imprinting from occurring when the magnetic recording medium wound in the form of roll on a core is heat treated or when the medium wound on a reel in a cartridge is stored under a high temperature condition, it is especially preferred to use an aramid support or a nonmagnetic support (preferably a polyester support or an aramid support) having a nonmagnetic film of a metal or a metallic inorganic compound formed on at least one side thereof by vapor deposition.

An aramid support undergoes smaller volume shrinkage in a heat treatment and is more effective in preventing back imprinting than a polyester support. By providing a nonmagnetic film of a metal or a metallic inorganic compound on at least one side of a nonmagnetic support by vapor deposition, volume shrinkage of the support in a heat treatment can be reduced thereby to ensure the prevention of back imprinting.

The aramid support is preferably made mainly of an aromatic polyamide. The aromatic polyamide preferably contains at least 50 mol %, more preferably 70 mol % or more, of at least one of a repeating unit represented by formula (I) and a repeating unit represented by formula (II):

-(—NH—Ar₁—NHCO—Ar₂—CO—)- (I)

-(—NH—Ar₃—CO—)- (II)

wherein Ar₁, Ar₂, and Ar₃ each represent an aromatic ring, for example,

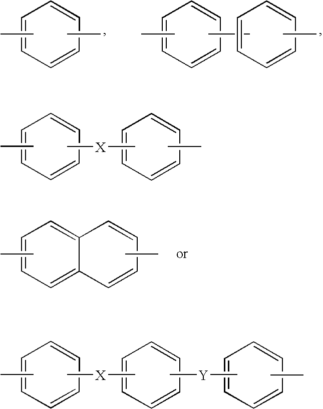

and each of X and Y represents, but is not limited to, —O—, —CH₂—, —CO—, —SO₂—, —S—, or —C(CH₃)₂—.

In formulae (I) and (II), part of the hydrogen atoms on the aromatic ring may be displaced with a halogen atom (particularly chlorine), a nitro group, a C1-C3 alkyl group (particularly methyl), a C1-C3 alkoxy group, or a like substituent. The hydrogen atom of the amide linkages constructing the polymer chain may be displaced with a substituent.

The aromatic polyamide in which at least 50%, more preferably at least 75 mol %, of the total aromatic rings are bonded at para positions is preferred in terms of strength and heat resistance of the support. The aromatic polyamide in which at least 30% of the total aromatic rings have part of their hydrogen atoms displaced with a halogen substituent, especially chlorine, is preferred as having reduced hygroscopicity.

As stated above, the aromatic polyamide of the aramid support preferably contains at least 50 mol % of at least one of repeating units of formulae (I) and (II). That is, less than 50 mol % of the polyamide may be derived from other repeating units, or the aromatic polyamide may be a polyblend containing not more than 50% of other aromatic polyamide. The aramid support may contain conductive particles, a slip agent, an antioxidant, and other additives in amounts that do not impair the physical properties of the support.

Commercially available aramid supports that can be used in the invention include Mictron from Toray Industries, Inc.

Types of the nonmagnetic metal used to form a film on at least one side of a nonmagnetic support by vapor deposition include elemental metals, semi-metals, alloys, and intermetallic compounds. Examples of the elemental metals are Mg, Ca, Al, Ti, V, Cr, Mn, Fe, Co, Ni, Cu, Zn, Zr, Nb, Mo, Pd, Ag, Sn, Ta, W, Pt, Au, and Pd. Examples of the semi-metals are C, Si, Ge, Sb, and Te. The alloys and intermetallic compounds are derived from these metals or semi-metals.

The nonmagnetic metallic inorganic compounds used to form a film on at least one side of a nonmagnetic support by vapor deposition include oxides, nitrides, carbides, borides, sulfides, and chlorides of the metals recited above. Examples of the oxides are CuO, ZnO, Al₂O₃, SiO₂, Fe₂O₃, Fe₃O₄, Ag₂O, TiO₂, MgO, SnO₂, ZrO₂, InO₃, and MoO₃. Examples of the nitrides are TiN, GaN, TaN, and AlN. Examples of the carbides are TiC, WC, SiC, NbC, ZrC, and Fe₃C. These metallic inorganic compounds may be used either individually or in combination of two or more thereof.

An aluminum-containing film is preferred from the standpoint of film strength and productivity. A film made mainly of metallic aluminum or aluminum oxide is particularly preferred.

The oxygen concentration in the metal oxide film is preferably at least 5 at %, more preferably 5 to 70 at %, even more preferably 10 to 60 at %. The metal oxide film with an appropriately controlled oxygen concentration exhibits good toughness and scratch resistance. The oxygen concentration in the deposited film is preferably controlled by introducing oxygen into vapor deposition chamber through an oxygen supply nozzle.

Vapor deposition techniques that can be used to form the film include physical vapor deposition (e.g., vacuum evaporation and sputtering) and chemical vapor deposition. Physical vapor deposition is preferred.

In order to make a high-capacity magnetic recording medium, the nonmagnetic support is preferably as thin as possible. The thickness of the support is preferably 10 μm or less, more preferably 2 to 8 μm, even more preferably 3 to 7 μm, most preferably 4 to 6 μm. With a support thickness of 2 μm or more, the magnetic recording medium is prevented from breaking in use. With a support thickness of 10 μm or less, the magnetic recording medium is able to achieve high capacity.

The nonmagnetic support used to make the magnetic recording medium usually has its surface roughness adjusted by the incorporation of inert fine particles, e.g., of kaolin, talc, titanium dioxide, silicon dioxide (silica), calcium phosphate, aluminum oxide, zeolite, lithium fluoride, calcium fluoride, barium sulfate, carbon black, or heat resistant polymers such as described in JP 59-5216B. It is preferred for the inert fine particles to have a narrower particle size distribution.

The nonmagnetic support preferably has a center-line average surface roughness (Ra) of 1 to 50 nm, more preferably 1 to 25 nm, even more preferably 2 to 15 nm, most preferably 3 to 10 nm, on both sides thereof (i.e., on the side where a magnetic layer is to be provided and the other side where a backcoat layer is to be provided). The support with an Ra of 1 nm or more is easy to handle during the manufacture of the magnetic recording medium. As long as the Ra of the support being 50 nm or smaller, the surface profile of the support will not be so influential on that of the magnetic layer or the backcoat layer.

The Ra of the support may be measured with a three-dimensional imaging surface structure analyzer, New View series from Zygo Corp.

The support for use in the invention preferably has a thermal shrinkage of not more than 3%, more preferably not more than 1.5%, when left to stand at 100° C. for 30 minutes. The thermal shrinkage of the support at 80° C. for 30 minutes is preferably not more than 1%, more preferably not more than 0.5%. The support preferably has a breaking strength of 5 to 100 kg/mm² (49 to 980 Mpa) and a modulus of elasticity of 100 to 2000 kg/mm² (0.98 to 19.6 GPa). The support preferably has a coefficient of thermal expansion of 10⁻⁴ to 10⁻⁸/° C., more preferably 10⁻⁵ to 10⁻⁶/° C., and a coefficient of humidity expansion of 10⁻⁴/RH % or less, more preferably 10⁻⁵/RH % or less. The support is preferably almost isotropic in these thermal, dimensional, and mechanical characteristics in its plane. Specifically, the difference in these characteristics depending on the planar direction is preferably within ±10%.

The nonmagnetic support may be subjected to various treatments, such as a corona discharge treatment, a plasma treatment, a heat treatment, and a cleaning treatment.

The ferromagnetic powders that can be used in the magnetic layer include ferromagnetic hexagonal ferrite powder and ferromagnetic metal powder.

Examples of the hexagonal ferrite powder that can be used include barium ferrite, strontium ferrite, lead ferrite, and calcium ferrite, and their doped compounds, such as Co-doped ferrites. Specific examples are barium ferrite and strontium ferrite of magnetoplumbite type; magnetoplumbite type ferrites coated with spinel; and barium ferrite and strontium ferrite of magnetoplumbite type containing a spinel phase in parts. These ferrites may contain, in addition to the prescribed atoms, other elements, such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb, and Zr. Usually, ferrites doped with Co—Zn, Co—Ti, Co—Ti—Zr, Co—Ti—Zn, Ni—Ti—Zn, Nb—Zn—Co, Sb—Zn—Co, Nb—Zn, etc. can be used. The ferrite may contain impurities inherent to the raw materials and the process of preparation.

The hexagonal grains of the ferrite preferably has a tabular diameter of 5 to 100 nm, more preferably 10 to 60 nm, even more preferably 10 to 50 nm. In the case of magnetic recording medium with an increased track density that is reproduced with an MR head, the tabular diameter is preferably 40 nm or smaller so as to lower the particle noise. With a tabular diameter of at least 5 nm, the thermal fluctuation is reduced to stabilize the magnetization. With the diameter being 100 nm or smaller, the noise is prevented from increasing, which is advantageous for high density magnetic recording. The aspect ratio (diameter/thickness) is preferably 1 to 15, more preferably 1 to 7. Particles with an aspect ratio of 1 or higher are highly packed in a magnetic layer and exhibit sufficient orientation. With an aspect ratio of 15 or lower, the noise due to particles' stacking is reduced. In connection with the particle size, the particles within the above-recited size ranges have a BET specific surface area (S_{BET}) of 10 to 100 m²/g, which approximately corresponds to a surface area arithmetically calculated from the diameter and the thickness. It is usually preferred for the hexagonal ferrite powder to have as narrow a particle size (diameter and thickness) distribution as possible. Although it is difficult to quantify the size distribution, comparison can be made among, e.g., 500 particles randomly chosen from a transmission electron micrograph. While the size distribution is mostly not normal, the coefficient of variation represented by the standard deviation a divided by the mean size (σ/mean) is 0.1 to 2.0. In order to make the particle size distribution sharper, the reaction system for particle formation is made as uniform as possible, and the particles produced are subjected to treatment for distribution improvement. For example, selective dissolution of ultrafine particles in an acid solution is among known treatments.

It is generally possible to prepare hexagonal ferrite powder having a coercive force (He) of about 500 to 5000 Oe (40 to 398 kA/m). Although a higher Hc is more advantageous for high density recording, the upper limit of Hc depends on the ability of the write head used. The coercive force (Hc) of the hexagonal ferrite powder used in the invention is preferably about 2000 to 4000 Oe (160 to 320 kA/m), still preferably 2200 to 3500 Oe (176 to 280 kA/m). Where the saturation magnetization (as) of the head exceeds 1.4 T, it is desirable that the coercive force of the ferrite powder be 2200 Oe (176 kA/m) or more. The coercive force can be controlled by the particle size (diameter and thickness), the kind and amount of constituent elements, the substitution site of elements, conditions of particle formation, and the like.

The hexagonal ferrite powder preferably has a saturation magnetization (σs) of 40 to 80 A·m²/kg. A relatively high as within that range is desirable. A saturation magnetization tends to decrease as the particle size becomes smaller. It is well known that the saturation magnetization can be improved by using a magnetoplumbite type ferrite combined with a spinal type ferrite or by properly selecting the kinds and amounts of constituent elements. It is also possible to use a W-type hexagonal ferrite powder for that purpose.

For the purpose of improving dispersibility, it is practiced to treat hexagonal ferrite powder with a surface treating agent compatible with a dispersing medium or a binder resin. Organic or inorganic compounds may be used as the surface treating agent. Typical examples are oxides or hydroxides of Si, Al or P, silane coupling agents, and titanium coupling agents. The surface treating agent is usually used in an amount of 0.1% to 10% by mass based on the ferrite powder. The pH of the hexagonal ferrite powder is of importance for dispersibility. The pH is usually adjusted to about 4 to 12. While the pH should be optimized according to the dispersing medium or binder resin, a pH of about 6 to 11 is recommended from the standpoint of chemical stability and storage stability of the magnetic recording medium. The water content of the ferrite powder is also influential on dispersibility. While varying according to the kind of the dispersing medium or binder resin, the optimal water content usually ranges from 0.01% to 2.0% by mass.

The hexagonal ferrite powder can be prepared by, for example, (1) a process by controlled crystallization of glass which includes the steps of blending barium oxide, iron oxide, an oxide of a metal that is to substitute iron, and a glass forming oxide (e.g., boron oxide) in a ratio providing a desired ferrite composition, melting the blend, rapidly cooling the melt into an amorphous solid, re-heating the solid, washing and grinding the solid to obtain a barium ferrite crystal powder, (2) a hydrothermal process which includes the steps of neutralizing a solution of barium ferrite-forming metal salts with an alkali, removing by-products, heating in a liquid phase at 100° C. or higher, washing, drying, and grinding to obtain a barium ferrite crystal powder, and (iii) a coprecipitation process which includes the steps of neutralizing a solution of barium ferrite-forming metal salts with an alkali, removing by-products, drying, treating at 1100° C. or lower, and grinding to obtain a barium ferrite crystal powder. The production of the hexagonal ferrite powder for use in the invention is not limited to any particular process.

The ferromagnetic metal powder that can be used in the magnetic layer is not particularly limited. A ferromagnetic alloy powder having α-Fe as a main ingredient is preferred. The ferromagnetic metal powder may contain, in addition to prescribed atom, Al, Si, 5, Sc, Ca, Ti, V, Cr, Cu, Y, Mo, Rh, Pd, Ag, Sn, Sb, Te, Ba, Ta, W, Re, Au, Hg, Ph, Bi, La, Ce, Pr, Nd, P, Co, Mn, Zn, Ni, Sr, B, etc. Ferromagnetic powders containing at least one of Al, Si, Ca, Y, Ba, La, Nd, Co, Ni, and B in addition to α-Fe, particularly those containing at least one of Co, Al, and Yin addition to α-Fe are preferred. More specifically, the Co content is preferably 0 to 50 at %, more preferably 15 to 35 at %, even more preferably 20 to 35 at %, based on Fe. The Y content is preferably 1.5 to 12 at %, more preferably 3 to 10 at %, even more preferably 4 to 9 at %, based on Fe. The Al content is preferably 1.5 to 12 at %, more preferably 3 to 10 at %, even more preferably 4 to 9 at %, based on Fe.

The ferromagnetic metal powder may previously be treated with a dispersant, a lubricant, a surfactant, an antistatic agent, and so on before being dispersed. Specific description of such treatments is given in JP 44-14090B, JP 45-18372B, JP 47-22062B, JP 47-22513B, JP 46-28466B, JP 46-38755B, JP 47-4286B, JP 47-12422B, JP 47-17284B, JP 47-18509B, JP 47-18573B, JP 39-10307B, JP 46-39639B, and U.S. Pat. Nos. 3,026,215, 3,031,341, 3,100,194, 3,242,005, and 3,389,014.

The ferromagnetic metal powder may contain a small amount of a hydroxide or an oxide. The ferromagnetic metal powder can be prepared by known processes, including reduction of a composite organic acid salt (mainly an oxalate) with a reducing gas (e.g., hydrogen); reduction of iron oxide with a reducing gas (e.g., hydrogen) into Fe or Fe—Co particles; pyrolysis of a metal carbonyl compound; reduction of a ferromagnetic metal in the form of an aqueous solution by adding a reducing agent (e.g., sodium borohydride, a hypophosphite, or hydrazine); and vaporization of a metal in a low-pressure inert gas. The resulting ferromagnetic metal powder may be subjected to a known slow oxidation treatment. Slow oxidation treatment is achieved by, for example, a method in which ferromagnetic metal powder as obtained is immersed in an organic solvent, followed by drying, a method in which the powder is immersed in an organic solvent, and oxygen-containing gas is bubbled in the solvent to form an oxide film on the surface of powder particles, followed by drying, or a method in which the powder is treated in an atmosphere having a controlled oxygen to inert gas ratio to form an oxide film on its surface without using an organic solvent.

The ferromagnetic metal powder preferably has a BET specific surface area of 45 to 100 m²/g, still preferably 50 to 80 m²/g, so as to secure both satisfactory surface properties and low noise. The ferromagnetic metal powder preferably has a crystallite size of 8 to 18 nm, still preferably 10 to 18 nm, even still preferably 11 to 17.5 nm. The ferromagnetic metal powder preferably has a length of 0.01 to 0.15 μm, still preferably 0.02 to 0.10 μm, even still preferably 0.03 to 0.08 μm with an aspect ratio of 3 to 15, still preferably 5 to 12. The ferromagnetic metal powder preferably has a saturation magnetization σS of 90 to 180 A·m²/kg, still preferably 100 to 150 A·m²/kg, even still preferably 105 to 140 A·m²/kg; and a coercive force Hc of 2000 to 3500 Oe (160 to 280 kA/m), more preferably 2200 to 3000 Oe (176 to 240 kA/m).

The water content of the ferromagnetic metal powder preferably ranges from 0.01% to 2% by mass. The water content of the ferromagnetic metal powder is preferably optimized according to the kind of the binder to be combined with. The pH of the ferromagnetic metal powder, which is preferably optimized according to the kind of the binder to be combined with, usually ranges from 4 to 12, preferably 6 to 10. Where needed, the ferromagnetic metal powder may be surface treated with Al, Si, P, or an oxide thereof. The amount of the surface treatment may be 0.1% to 10% by mass relative to the ferromagnetic metal powder. The thus surface treated ferromagnetic metal powder will have an adsorption of a lubricant (e.g., a fatty acid) of not more than 100 mg/m². The ferromagnetic metal powder may contain soluble inorganic ions, such as Na, Ca, Fe, Ni, and Sr ions. While the absence of such ions is essentially desirable, presence in a total concentration up to about 200 ppm is little influential on the characteristics. The void of the ferromagnetic metal powder is preferably as small as possible. The void is preferably 20% by volume or less, still preferably 5% by volume or less. The ferromagnetic metal powder may have an acicular shape, a spindle shape, or any other general shape as long as the particle size parameters fall within the above-specified ranges. The SFD (switching field distribution) of the magnetic powder itself is preferably as small as possible. A preferred SFD is 0.8 or smaller. The ferromagnetic metal powder preferably has a narrow Hc distribution. Ferromagnetic metal powder having an SFD of 0.8 or smaller shows good electromagnetic characteristics, high output, and a sharp magnetization reversal with a small peak shift, which is advantageous for high density digital magnetic recording. The coercivity distribution can be narrowed by, for example, using goethite with a narrow size distribution, or preventing sintering of particles in the preparation of the ferromagnetic metal powder.

The binder of the magnetic layer is preferably chosen from polyurethane resins, polyester resins, and cellulose acetate in view of finely dispersing properties for ferromagnetic powder and environmental durability (against temperature and humidity changes). A polyurethane resin and a polyester resin are more preferred. A polyurethane resin is the most preferred. The polyurethane resin binder may have any known structure, such as polyester polyurethane, polyether polyurethane, polyether polyester polyurethane, polycarbonate polyurethane, polyester polycarbonate polyurethane, and polycaprolactone polyurethane.

The binder preferably contains a binder component containing a resin having a mass average molecular weight (Mw) of more than 120,000 for the following reason. In the cases where a magnetic recording medium is produced in a successive multilayer coating method, which is preferably adopted in the invention, magnetic orientation treatment after application of a magnetic coating composition can cause the ferromagnetic powder particles to aggregate. This phenomenon, called oriented aggregation, occurs conspicuously when in using a low concentration magnetic coating composition to form a thin magnetic layer because the ferromagnetic particles are allowed to move more easily and thereby more liable to aggregate as the coating composition becomes thinner.

To prevent the oriented aggregation, it is effective to use a binder component containing, as a constituent, a resin having a higher molecular weight than binder resins conventionally employed in the art, specifically a mass average molecular weight (Mw) of more than 120,000. The resin with an Mw of more than 120,000 will hereinafter be referred to as a resin A.

It is considered that the resin A having the molecular weight stated is highly adsorptive for ferromagnetic powder particles so that the binder containing the resin A has an increased adsorptivity for ferromagnetic particles in the magnetic coating composition. As a result, the ferromagnetic particles exhibit increased three dimensional repulsion to each other in the magnetic coating composition and are thereby prevented from aggregating during orientation processing. Two or more resins A may be used in combination.

The Mw of a binder resin may be determined by gel permeation chromatography (GPC).

In view of solubility and easy of synthesis, the Mw of the resin A is preferably less than 500,000, more preferably 120,000 to 300,000, even more preferably 150,000 to 250,000.

The magnetic layer preferably contains the resin A in an amount of at least 2.5% by mass based on the ferromagnetic powder. In other words, it is preferred that the magnetic layer of the magnetic recording medium of the invention be formed using a magnetic coating composition containing at least 2.5% by mass of the resin A based on the ferromagnetic powder so that the binder has sufficient adsorptivity for ferromagnetic powder to effectively prevent oriented aggregation of the powder. The amount of the resin A in the magnetic layer is more preferably 4% to 40%, even more preferably 5% to 30%, most preferably 5% to 25%, by mass based on the ferromagnetic powder.

The resin A preferably has a Tg of −50° to 150° C., more preferably 0° to 100° C., even more preferably 30° to 90° C. The resin A preferably has an elongation at break of 100% to 2000%, a stress at break of 0.05 to 10 kg/mm² (0.49 to 98 Mpa), and a yield point of 0.05 to 10 kg/mm² (0.49 to 98 Mpa). The resin A may be synthesized by known methods or commercially available.

The binder component may be the resin A per se or a reaction product of the resin A and a compound having a thermosetting functional group. The magnetic recording medium of the invention is preferably produced by forming a nonmagnetic layer on a nonmagnetic support and then applying a magnetic coating composition on the nonmagnetic layer, followed by drying. When a magnetic layer is formed by applying a coating composition containing the resin A without adding a compound having a thermosetting functional group, there is formed a magnetic layer containing the resin A per se as a binder component. When a compound having a thermosetting functional group is added to the coating composition along with the resin A, a curing reaction (crosslinking reaction) is induced by the heat, e.g., of calendering or heat treatment after the application, yielding a magnetic layer containing the reaction product of the resin A and the compound as a binder component. As will be described below, when adding a resin component in addition to the resin A and the compound having a thermosetting functional group to the magnetic coating composition, the resultant reaction product may include a copolymer of the resin A, the compound containing a thermosetting functional group, and the additional resin component.

The compound having a thermosetting functional group is preferably a compound having an isocyanate group as the functional group, and more preferably a polyisocyanate having two or more isocyanate groups. Examples of the polyisocyanate include tolylene diisocyanate, 4,4′-diphenylmethane diisocyanate, hexamethylene diisocyanate, xylylene diisocyanate, naphthylene 1,5-diisocyanate, o-toluidine diisocyanate, isophorone diisocyanate, and triphenylmethane triisocyanate; reaction products between these isocyanate compounds and polyalcohols; and polyisocyanates produced by condensation of these isocyanates.

These isocyanates are commercially available under the following trade names, for example: Coronate L, Coronate HL, Coronate 2030, Coronate 2031, Millionate MR, and Millionate MTL manufactured by Nippon Polyurethane Industry Co. Ltd.; Takenate D-102, Takenate D-110N, Takenate D-200, and Takenate D-202 manufactured by Takeda Chemical Industries Co., Ltd.; and Desmodule L, Desmodule IL, Desmodule N, and Desmodule HL manufactured by Sumitomo Bayer Co., Ltd. They can be used singly or, two or more of them different in curing reactivity may be used in combination.

The binder can contain other binder components in addition to the above described binder component. Examples of the other binder components that may be employed in combination with the above described binder component are conventionally known thermoplastic resins, thermosetting resins, reactive resins, and mixtures thereof. The glass transition temperature of thermoplastic resins used in combination is preferably −100° to 200° C., more preferably −50° to 150° C.

Specific examples of the thermoplastic resins that can be used in combination include homo- and copolymers containing units derived from vinyl chloride, vinyl acetate, vinyl alcohol, maleic acid, acrylic acid, acrylic esters, vinylidene chloride, acrylonitrile, methacrylic acid, methacrylic esters, styrene, butadiene, ethylene, vinyl butyral, vinyl acetal, vinyl ether, and so on; polyurethane resins, various rubber resins, and cellulose esters.

Examples of the thermosetting resins and reactive resins that can be used in combination include phenol resins, epoxy resins, curing polyurethane resins, urea resins, melamine resins, alkyd resins, acrylic reactive resins, formaldehyde resins, silicone resins, epoxy-polyamide resins, polyester resin/isocyanate prepolymer mixtures, polyester polyol/polyisocyanate mixtures, and polyurethane/polyisocyanate mixtures. The details of these resins are described in Plastic Handbook, Asakura Shoten. Known electron beams curing resins are also usable. Examples of such resins and their manufacturing methods are described in detail in JP 62-256219A.

The aforementioned resins may be used either individually or in combination. Preferred resins are combinations of a polyurethane resin and at least one of a vinyl chloride resin, a vinyl chloride-vinyl acetate copolymer, a vinyl chloride-vinyl acetate-vinyl alcohol copolymer, and a vinyl chloride vinyl acetate-maleic anhydride copolymer. These combinations of resins may further be combined with a polyisocyanate. Vinyl chloride resins are particularly preferred. Combining a vinyl chloride resin further increases dispersing properties for the ferromagnetic powder, which is effective in improving electromagnetic characteristics and reducing head staining.

In order to ensure dispersing capabilities for powder and durability according to necessity, it is preferred to introduce into each the above-recited binder components at least one polar group by copolymerization or through addition reaction, the polar group being selected from —COOM, —SO₃M, —OSO₃M, —P═O(OM)₂, —O—P═O(OM)₂ (wherein M is a hydrogen atom or an alkali metal), —OH, —NR₂, —N⁺R₃ (wherein R is a hydrocarbon group), an epoxy group, —SH, —CN, and so on. The amount of the polar group to be introduced is preferably 10⁻¹ to 10⁻⁸ mol/g, still preferably 10⁻² to 10⁻⁶ mol/g.

Examples of commercially available binder components useful in the invention are VAGH, VYHH, VMCH, VAGF, VAGD, VROH, VYES, VYNC, VMCC, XYHL, XYSG, PKHH, PKHJ, PKHC, and PKFE (from Union Carbide Corp.); MPR-TA, MPR-TAS, MPR-TAL, MPR-TSN, MPR-TMF, MPR-TS, MPR-TM, and MPR-TAO (from Nisshin Chemical Industry Co., Ltd.); 1000W, DX80, DX81, DX82, DX83, and 100FD (from Denki Kagaku Kogyo K.K.); MR-104, MR-105, MR110, MR100, MR555, and 400X-110A (from Zeon Corp.); Nipporan N2301, N2302, and N2304 (from Nippon Polyurethane Industry Co., Ltd.); Pandex T-5105, T-R3080, and T-5201, Barnock D-400 and D-210-80, and Crisvon 6109 and 7209 (from DIC, Inc.); Vylon UR8200, UR8300, UR-8700, RV530, and RV280 (from Toyobo Co., Ltd.); Daiferamin 4020, 5020, 5100, 5300, 9020, 9022, and 7020 (from Dainichiseika Color & Chemicals Mfg. Co., Ltd.); MX5004 (from Mitsubishi Chemical Corp.); Sanprene SP-150 (from Sanyo Chemical Industries, Ltd.); and Saran F310 and F210 (from Asahi Chemical Industry Co., Ltd.).

When the coating composition for magnetic layer contains the thermosetting functional group-containing compound as well as the resin A, a crosslinking reaction proceeds between the resin A and the compound in a coating layer while heating the layer to provide a magnetic layer containing the reaction product between the rein A and the compound. The resulting magnetic layer has a higher coating film strength than a magnetic layer containing the resin A itself and therefore provides a more durable magnetic recording medium. When the coating composition for magnetic layer contains the thermosetting functional group-containing compound, the amount of the compound is preferably 5% to 40%, more preferably 10% to 30%, even more preferably 15% to 25%, by mass based on the total binder components used to form the magnetic layer.

As set forth above, the magnetic layer may contain the resin A and the other binder components (such as the thermosetting functional group-containing compound and the other resin components), the details of which have previously been described. In order to avoid the oriented aggregation problem by the addition of the resin A while retaining good electromagnetic characteristics, the proportion of the resin A in the total binder components is preferably 10% to 80%, more preferably 20% to 60%, even more preferably 20% to 40%, by mass. The amount of a binder component other than the resin A in the magnetic layer is preferably at least 2.5%, more preferably 4% to 40%, even more preferably 5% to 30%, most preferably 5% to 25%, by mass based on the ferromagnetic powder so as to produce the effect expected of that component.

The thickness of the magnetic layer of the magnetic recording medium of the invention preferably ranges from 0.01 to 0.20 μm. Using the resin A as a binder component to form the magnetic layer is effective in preventing the oriented aggregation problem often arising when such a relatively thin magnetic layer is formed by a successive multilayer coating method. A magnetic recording medium with high electromagnetic characteristics can thus be obtained. The thickness of the magnetic layer is more preferably 0.02 to 0.15 μm, even more preferably 0.03 to 0.12 μm.

It is preferred for the magnetic layer surface to have as small a centerline average surface roughness Ra as possible. The surface roughness Ra of the magnetic layer is determined using an AFM. The Ra of the magnetic layer is preferably 10.0 nm or less, more preferably 1.0 to 8.0 nm, even more preferably 2.0 to 6.0 nm, most preferably 2.5 to 5.0 nm. The number of micro protrusions of 10 to 20 nm in height on the magnetic layer surface is preferably 1 to 500 per 100 μm², more preferably 3 to 250 per 100 μm², even more preferably 5 to 150 per 100 μm², most preferably 5 to 100 per 100 μm².

The Ra of the magnetic layer is dependent on the surface profile of the nonmagnetic support, the dispersibility of the ferromagnetic powder in the magnetic layer, the particle size and amount of particulate additives used in the magnetic layer, such as an abrasive and carbon black, and the like. The Ra of the magnetic layer can be reduced by, for example, improving the fine dispersibility of the ferromagnetic powder, decreasing the abrasive or carbon black particle size, or reducing the amount of the abrasive or carbon black.

The surface profile of the magnetic layer can also be controlled by adjusting the calendering conditions. For example, the Ra and the number of micro protrusions can be reduced by increasing the linear pressure, extending the pressure application time, or elevating the calendering temperature.

The magnetic layer preferably has a surface resistivity of 1×10⁴ to 1×10⁸ Ω/sq, more preferably 1×10⁵ to 1×10⁷ Ω/sq, even more preferably 1×10⁵ to 5×10⁶ Ω/sq, most preferably 1×10⁵ to 5×10⁶ Ω/sq. The surface resistivity of the magnetic layer may be measured using the electrodes illustrated in FIG. 1 of JP 2008-77698A.

Appropriate control of the surface resistivity of the magnetic layer prevents static electrification of the magnetic recording medium thereby preventing electrostatic adhesion of dust and debris that may cause a dropout. To control the surface resistivity of the magnetic layer to the recited range is preferred because the magnetic recording medium is readily electrified particularly in a dry atmosphere, such as a low temperature low humidity environment.

The surface resistivity of the magnetic layer is adjustable by incorporating an adequate amount of a conductive material into at least one of the magnetic layer and the nonmagnetic layer. It is preferred for surface resistivity control of the magnetic layer to incorporate a conductive material to the magnetic layer or a layer as close as possible to the magnetic layer.

The nonmagnetic layer contains at least a nonmagnetic powder and a binder.

The nonmagnetic layer is not particularly limited and may contain magnetic powder as long as it is substantially nonmagnetic. The phrase “substantially nonmagnetic” means that existence of a small amount of magnetic powder that would not substantially influence the electromagnetic characteristics of the magnetic layer is acceptable. More specifically, the “substantially nonmagnetic” layer has a residual magnetic flux density of not more than 0.01 T or a coercive force of not more than 7.96 kA/m (100 Oe) and preferably has no residual magnetic flux density nor coercive force.

The nonmagnetic powder that can be used in the nonmagnetic layer are selected from inorganic compounds, such as metal oxides, metal carbonates, metal nitrides, metal carbides, and metal sulfides. Examples of the inorganic compounds include α-alumina having an α-phase content of 90% or more, β-alumina, γ-alumina, θ-alumina, silicon carbide, chromium oxide, cerium oxide, α-iron oxide, hematite, goethite, corundum, silicon nitride, titanium carbide, titanium oxide, silicon dioxide, tin oxide, magnesium oxide, tungsten oxide, zirconium oxide, boron nitride, zinc oxide, calcium carbonate, barium sulfate, and molybdenum disulfide. They can be used either individually or in combination. Preferred among them are titanium dioxide, zinc oxide, α-iron oxide, and barium sulfate, particularly titanium dioxide and α-iron oxide, because they can be prepared with a small particle size distribution and be endowed with a desired function through many means. While the nonmagnetic powder preferably has an average particle size of 0.05 to 2 μm, nonmagnetic powders different in average particle size may be used in combination, or a single kind of a nonmagnetic powder having a broadened size distribution may be used to produce the same effect. A particularly preferred particle size of the nonmagnetic powder is 0.01 to 0.2 μm. In particular, a non-acicular metal oxide powder preferably has an average particle size of 0.08 μm or smaller, and an acicular metal oxide powder preferably has a length of 0.3 μm or shorter, still preferably 0.2 μm or shorter. The tap density of the nonmagnetic powder is 0.05 to 2g/ml, still preferably 0.2 to 1.5 g/ml. The water content of the nonmagnetic powder is preferably 0.1% to 5% by mass, still preferably 0.2% to 3% by mass, even still preferably 0.3% to 1.5% by mass. The pH of the nonmagnetic powder is preferably from 2 to 11, still preferably from 5.5 to 10.

The specific surface area of the nonmagnetic powder preferably ranges 1 to 100 m²/g, still preferably 5 to 80 m²/g, even still preferably 10 to 70 m²/g. The crystallite size is preferably 0.004 to 1 μm, still preferably 0.04 to 0.1 μm. The oil (DBP) absorption of the powder is preferably 5 to 100 ml/100 g, still preferably 10 to 80 ml/100 g, even still preferably 20 to 60 ml/100 g. The specific gravity of the powder is preferably 1 to 12, still preferably 3 to 6. The particle shape may be any of acicular, spherical, polygonal and tabular shapes. The Mohs hardness is preferably 4 to 10. The SA (stearic acid) adsorption of the nonmagnetic powder is preferably in a range of 1 to 20 μmol/m², still preferably 2 to 15 μmol/m², even still preferably 3 to 8 μmol/m². The pH of the powder is preferably between 3 and 6.

It is preferred that the nonmagnetic powder be subjected to surface treatment to have a surface layer of one or more of Al₂O₃, SiO₂, TiO₂, ZrO₂, SnO₂, Sb₂O₃, ZnO, and Y₂O₃. Among these surface treating material, preferred for dispersibility are Al₂O₃, SiO₂, TiO₂, and ZrO₂, with Al₂O₃, SiO₂, and ZrO₂ being still preferred. They may be used either individually or in combination. According to the purpose, a composite surface layer can be formed by co-precipitation or a method comprising first applying alumina to the nonmagnetic particles and then treating with silica or vice versa. The surface layer may be porous for some purposes, but a homogeneous and dense surface layer is usually preferred.

Specific examples of commercially available nonmagnetic powders that can be used in the nonmagnetic layer include Nanotite from Showa Denko K.K.; HIT-100 and ZA-G1 from Sumitomo Chemical Co., Ltd.; α-Hematite DPN-250, DPN-250BX, DPN-245, DPN-270BX, DPN-550BX, DBN-SA1, and DBN-SA3 from Toda Kogyo Corp.; titanium oxide series TTO-51B, TTO-55A, TTO-55B, TTO-55C, TTO-55S, and UO-55D, SN-100, and α-hematite series E270, E271, E300, and E303 from Ishihara Sangyo Kaisha, Ltd.; titanium oxide series STT-4D, STT-30D, STT-30, and STT-65C, and α-hematite α-40 from Titan Kogyo K.K.; MT-100S, MT-100T, MT-150W, MT-500B, MT-600B, T-100F, and T-500HD from Tayca Corp.; FINEX-25, BF-1, BF-10, BF-20, and ST-M from Sakai Chemical Industry Co., Ltd.; DEFIC-Y and DEFIC-R from Dowa Mining Co., Ltd.; AS2BM and TiO₂ P25 from Nippon Aerosil Co., Ltd.; 100A and 500A from Ube Industries, Ltd.; and calcined products thereof. Preferred of them are titanium dioxide products and α-iron oxide products.

The nonmagnetic layer may contain organic powder according to the purpose. Useful organic powders include acrylic-styrene resin powder, benzoguanamine resin powder, melamine resin powder, and phthalocyanine pigments. Polyolefin resin powder, polyester resin powder, polyamide resin powder, polyimide resin powder, and polyethylene fluoride resin powder are also usable. Methods of preparing these resin powders include those disclosed in JP 62-18564A and JP 60-255827A.

The binder components described above for use to make the magnetic layer, including thermoplastic resins, thermosetting resins, reactive resins, and mixture thereof, can be used to make the nonmagnetic layer. The amount of the binder in the nonmagnetic layer is preferably 5% to 50%, more preferably 10% to 30%, by mass based on the nonmagnetic powder. Where a vinyl chloride resin, a polyurethane resin, and polyisocyanate are used in combination, their amounts are preferably selected from a range of 5 to 30% by mass, a range of 2 to 20% by mass, and a range of 2 to 20% by mass, respectively. In case where head corrosion by a trace amount of released chlorine is expected to occur, polyurethane alone or a combination of polyurethane and polyisocyanate can be used. The polyurethane to be used preferably has a glass transition temperature of −50° to 150° C., still preferably 0° to 100° C., even still preferably 30° to 90° C., an elongation at break of 100 to 2000%, a stress at break of 0.05 to 10 kg/mm² (0.49 to 98 Mpa), and a yield point of 0.05 to 10 kg/mm² (0.49 to 98 Mpa).

The binder formulation used to make the nonmagnetic layer may be varied according to necessity in terms of the binder content, the proportions of a vinyl chloride resin, a polyurethane resin, polyisocyanate, and other resins, the molecular weight of each resin, the amount of the polar group introduced, and other physical properties of the resins. Known techniques for binder designing can be used. For example, to increase the binder content of the nonmagnetic layer is effective to increase flexibility thereby to improve head touch.

Examples of the polyisocyanate for use in the nonmagnetic layer are the same as those recited above with respect to the magnetic layer component.

The nonmagnetic layer preferably has a thickness of 0.1 to 2.0 μm. Too thick a nonmagnetic layer results in the formation of a thick magnetic recording medium and makes it difficult to achieve high recording capacity. If the thickness is too small, on the other hand, the influence of the surface profile of the nonmagnetic support would appear on the magnetic layer surface, or the effect of the nonmagnetic layer in allowing the abrasive or carbon black on the magnetic layer surface to sink would be insufficient. The thickness is more preferably 0.2 to 1.5 μm, even more preferably 0.3 to 1.0 μm.

The magnetic recording medium of the invention may have carbon black incorporated into one or both of the magnetic layer and the nonmagnetic layer. Useful carbon blacks include furnace black for rubber, thermal black for rubber, carbon black for colors, and acetylene black. The carbon black preferably has a specific surface area of 5 to 500 m²/g, a DBP absorption of 10 to 400 ml/100 g, and an average particle size of 5 to 300 nm, more preferably 10 to 250 nm, even more preferably 20 to 200 nm. The carbon black preferably has a pH of 2 to 10, a water content of 0.1% to 10% by mass, and a tap density of 0.1 to 1 g/cc. Specific examples of commercially available carbon black products which can be used in the invention include Black Pearls 2000, 1300, 1000, 900, 905, 800, and 700 and Vulcan XC-72 from Cabot Corp.; #80, #60, #55, and #35 from Asahi Carbon Co., Ltd.; #2400B, #2300, #900, #1000, #30, #40, and #10B from Mitsubishi Chemical Corp.; Conductex SC, RAVEN 150, 50, 40, and 15, and RAVEN-MTP from Columbian Carbon; and Ketjen Black EC from Akzo Nobel Chemicals. Carbon black having been surface treated with a dispersant, etc., resin-grafted carbon black, or carbon black with its surface partially graphitized may be used. Carbon black may previously been dispersed in a binder before being added to a coating composition.

The above-enumerated carbon black species can be used either individually or as a combination thereof. The amount of carbon black, if added, is preferably 0.1% to 30% by mass based on the magnetic or nonmagnetic powder. Carbon black serves for antistatic control, reduction of friction coefficient (improvement of slip), reduction of light transmission, film strength enhancement, and the like. These functions vary depending on the species. As is well known, incorporating carbon black into the nonmagnetic layer brings about reduction of surface resistivity, reduction of light transmission, and achievement of a desired micro Vickers hardness. Addition of carbon black is also effective in holding the lubricant.

Accordingly, it is understandably possible to optimize the kinds and amounts of the carbon blacks for each layer according to the intended purpose with reference to the above-mentioned characteristics, such as particle size, oil absorption, conductivity, pH, and so forth. In selecting carbon black species for use in the magnetic and nonmagnetic layers, reference can be made, e.g., in Carbon Black Kyokai (ed.), Carbon Black Binran.

Known abrasives mostly having a Mohs hardness of 6 or higher can be used in the present invention, either individually or as a combination thereof. Such abrasives include α-alumina having an α-phase content of at least 90%, β-alumina, silicon carbide, chromium oxide, cerium oxide, α-iron oxide, corundum, artificial diamond, silicon nitride, titanium carbide, titanium oxide, silicon dioxide, and boron nitride. A composite of these abrasives (an abrasive surface treated with another) is also useful. Existence of impurity compounds or elements, which are sometimes observed in the abrasives, will not affect the effect as long as the content of the main component is at least 90% by mass. The particle size of the abrasive is preferably 0.01 to 2 μm, more preferably 0.05 to 1.0 μm, even more preferably 0.05 to 0.5 μm. The particle size distribution is preferably as narrow as possible to ensure the electromagnetic characteristics. Abrasive grains different in average particle size may be used in combination to improve durability, or a single kind of an abrasive having a broadened size distribution may be used to produce the same effect. The abrasive preferably has a tap density of 0.3 to 2 g/cc, a water content of 0.1% to 5% by mass, a pH of 2 to 11, and a specific surface area of 1 to 30 m²/g. The abrasive grains may be acicular, spherical or cubic. Angular grains are preferred for high abrasive performance. Specific examples of commercially available abrasives that can be used in the invention are AKP-12, AKP-15, AKP-20, AKP-30, AKP-50, HIT-20, HIT-30, HIT-55, HIT-60, HIT-70, HIT-80, and HIT-100 from Sumitomo Chemical Co., Ltd.; ERC-DBM, HP-DBM, and HPS-DBM from Reynolds Metals Co.; WA10000 from Fujimi Kenmazai K.K.; UB 20 from Uyemura & CO., LTD; G-5, Chromex U2, and Chromex U1 from Nippon Chemical Industrial Co., Ltd.; TF100 and TF140 from Toda Kogyo Corp.; Beta-Random Ultrafine from Ibiden Co., Ltd.; and B-3 from Showa Mining Co., Ltd. Incorporating the abrasive into the magnetic layer provides the magnetic recording medium with an enhanced head cleaning effect. Where needed, the abrasive may be incorporated into the nonmagnetic layer to allow for controlling the surface profile or the protrusion of the abrasive grains. As is understandable, it is preferred to optimize the grain size and the amount of the abrasive added to the magnetic or nonmagnetic layer.

The magnetic layer, nonmagnetic layer, and backcoat layer can contain other additives producing lubricating effects, antistatic effects, dispersing effects, plasticizing effects, and the like. Examples of useful additives include molybdenum disulfide, tungsten disulfide, graphite, boron nitride, graphite fluoride, silicone oils, polar group-containing silicones, fatty acid-modified silicones, fluorine-containing silicones, fluorine-containing alcohols, fluorine-containing esters, polyolefins, polyglycols, alkylphosphoric esters and alkali metal salts thereof, alkylsulfuric esters and alkali metal salts thereof, polyphenyl ethers, phenylphosphonic acid, α-naphtylphosphoric acid, phenylphosphoric acid, diphenylphosphoric acid, p-ethylbenzenephosphonic acid, phenylphosphinic acid, aminoquinones, various silane coupling agents, titan coupling agents, fluorine-containing alkylsulfuric esters and their alkali metal salts, saturated or unsaturated, straight-chain or branched monobasic fatty acids having 10 to 24 carbon atoms and their metal (e.g., Li, Na, K, Cu) salts, saturated or unsaturated, straight-chain or branched mono- to hexahydric alcohols having 12 to 22 carbon atoms, alkoxyalcohols having 12 to 22 carbon atoms, mono-, di- or tri-fatty acid esters between saturated or unsaturated, straight-chain or branched monobasic fatty acids having 10 to 24 carbon atoms and at least one of mono- to hexahydric, saturated or unsaturated, and straight-chain or branched alcohols having 2 to 12 carbon atoms, fatty acid esters of polyalkylene oxide monoalkyl ethers, fatty acid amides having 8 to 22 carbon atoms, and aliphatic amines having 8 to 22 carbon atoms.

Examples of the fatty acids are capric acid, caprylic acid, lauric acid, myristic acid, palmitic acid, stearic acid, behenic acid, oleic acid, elaidic acid, linoleic acid, linolenic acid, and isostearic acid. Examples of the esters are butyl stearate, octyl stearate, amyl stearate, isooctyl stearate, butyl myristate, octyl myristate, butoxyethyl stearate, butoxydiethyl stearate, 2-ethylhexyl stearate, 2-octyldodecyl palmitate, 2-hexyldodecyl palmitate, isohexadecyl stearate, oleyl oleate, dodecyl stearate, tridecyl stearate, oleyl erucate, neopentyl glycol didecanoate, and ethylene glycol dioleate. Examples of the alcohols are oleyl alcohol, stearyl alcohol, and lauryl alcohol. Surfactants also work well. Examples of useful surfactants include nonionic ones, such as alkylene oxide types, glycerol types, glycidol types, and alkylphenol ethylene oxide adducts; cationic ones, such as cyclic amines, ester amides, quaternary ammonium salts, hydantoin derivatives, heterocyclic compounds, phosphonium salts, and sulfonium salts; anionic ones containing an acidic group, such as a carboxyl group, a sulfonic acid group, a phosphoric acid group, a sulfuric ester group or a phosphoric ester group; and amphoteric ones, such as amino acids, aminosulfonic acids, amino alcohol sulfuric or phosphoric esters, and alkyl betaines. For the details of the surfactants, refer to Kaimen Kasseizai Binran, Sangyo Tosho K.K. The lubricants, surfactants, and like additives do not always need to be 100% pure and may contain impurities, such as isomers, unreacted materials, by-products, decomposition products, and oxidation products. Nevertheless, the proportion of the impurities is preferably 30% by weight at the most, more preferably 10% by mass or less.

Since the physical actions of these additives vary among individuals, the kind and amount of an additive or the mixing ratio of additives used in combination for producing a synergistic effect should be determined so as to produce optimum results according to the purpose. The following is a few examples of possible manipulations using additives. (1) Bleeding of fatty acid additives is suppressed by using fatty acids having different melting points between the magnetic layer and the nonmagnetic layer. (2) Bleeding of ester additives is suppressed by using esters different in boiling point, melting point or polarity between the magnetic layer and the nonmagnetic layer. (3) Coating stability is improved by adjusting the amount of a surfactant (4) The amount of the lubricant in the nonmagnetic layer is increased to improve the lubricating effect.

All or part of the additives can be added at any stage of preparing coating compositions for the magnetic, nonmagnetic, and backcoat layers. For example, the additives may be blended with the magnetic or nonmagnetic powder before kneading, be mixed with the magnetic or nonmagnetic powder, the binder, and a solvent in the step of kneading, or be added during or after the step of dispersing or immediately before application. The purpose of using an additive may also be achieved by separately applying a part of, or the whole of, the additive on the magnetic or nonmagnetic layer surface either by simultaneous coating or successive coating. A lubricant may be applied to the magnetic layer surface even after calendering or slitting, which depends on the purpose.

Known organic solvents, e.g., those described in JP 6-68453A, can be used in the preparation of the coating compositions.

Each of the coating compositions for the magnetic layer, nonmagnetic layer, and backcoat layer is preferably prepared by a method including the steps of kneading and dispersing and, if desired, the step of mixing which is provided before or after the step of kneading and/or the step of dispersing. Each step may be carried out in two or more divided stages. Any of the materials, including the magnetic powder, nonmagnetic powder, binder, abrasive, carbon black, abrasive, antistatic, lubricant, and solvent, may be added at the beginning of in the course of any step. Individual materials may be added in divided portions in two or more steps. For example, a binder may be added dividedly in the kneading step, the dispersing step, and a mixing step provided for adjusting the viscosity of the dispersion. To accomplish the object of the invention, known techniques for coating composition preparation can be applied as a part of the method. The kneading step is preferably performed using a kneading machine with high kneading power, such as an open kneader, a continuous kneader, a pressure kneader, and an extruder. In using a kneader, the magnetic or nonmagnetic powder is kneaded with a part (preferably at least 30% by mass of the total binder) or the whole of the binder and 15 to 500 parts by mass of a solvent per 100 parts by mass of the magnetic or nonmagnetic powder. For the details of the kneading operation, reference can be made in JP 1-106338A and JP 1-79274A. In the step of dispersing, it is preferred to use glass beads or high-specific-gravity dispersing beads, such as zirconia beads, titania beads, and steel beads, to disperse the coating composition. The size and mixing ratio of the dispersing beads should be optimized. Known dispersing machines can be used.

In forming the nonmagnetic layer, the magnetic layer, and the backcoat layer, any known application techniques can be used, including extrusion coating, roll coating, gravure coating, microgravure coating, air knife coating, die coating, curtain coating, dipping, and wire bar coating.

When the nonmagnetic layer and the magnetic layer are formed by a successive multilayer coating method, the magnetic layer is preferably formed by extrusion coating. In this case, the magnetic layer is preferably formed by a slot-extrusion coating system having an applicator head with two slots: a feed slot and a recovery (suction) slot, so that an excess of a coating composition fed from the feed slot on a moving web is sucked through the recovery slot. In carrying out this system, the pressure for sucking the applied coating composition through the recovery slot is preferably optimized so as to form a magnetic layer with a thin and yet uniform thickness.

The slot-extrusion coating system stated is carried out as follows. The applicator head is set with its extrusion slot lips close to the nonmagnetic layer of a moving nonmagnetic support. A coating composition for magnetic layer is delivered to the applicator head and extruded through the feed slot onto the nonmagnetic layer in excess of the amount required to form a magnetic layer with a designed thickness. The excess of the applied coating composition is sucked through the recovery slot provided downstream the feed slot. The liquid pressure P (Mpa) at the recovery slot is preferably controlled to satisfy relationship (I):

0.05 (Mpa)>P≧(Mpa) (I)

When a suction pump is used to suck the excess of the applied coating composition, the pressure PIN (PMa) at the inlet of the suction pump is preferably controlled to satisfy relationship (II):

PIN≧−0.02 (MP) (II)

For more details of the above described slot extrusion system, refer to JP 2003-236452A (corresponding to US 2003/0157251 A1).

The magnetic recording medium of the invention is preferably made by the following method. In a successive multilayer coating method, a coating composition for nonmagnetic layer is applied to a nonmagnetic support and dried to form a nonmagnetic layer, and, subsequently, a coating composition for magnetic layer is applied to the nonmagnetic layer and dried to form a magnetic layer. A simultaneous multilayer coating method in which a coating composition for magnetic layer is applied while the nonmagnetic layer is wet is also useful. The successive multilayer coating method is preferred in the invention.

The magnetic recording tape of the invention is preferably produced by successively forming a nonmagnetic layer and a magnetic layer on a continuous web from a roll of a nonmagnetic support, winding the coated web into roll, and slitting the coated web from the roll to width.

A coating composition for backcoat layer may previously be applied to the back side of the nonmagnetic support to prepare a roll of the backcoated nonmagnetic support or may be applied to the back side of the nonmagnetic support between the unrolling of the nonmagnetic support and the winding of the coated web either before or after the formation of the nonmagnetic layer and the magnetic layer.

The magnetic recording medium of the invention of tape form is preferably produced by the method including successively forming a nonmagnetic layer, a magnetic layer, and a backcoat layer on an unrolled, continuous web of a nonmagnetic support, winding the coated web into roll, and slitting the roll. When a backcoat layer is formed without once winding a continuous web of a nonmagnetic support having a nonmagnetic layer and a magnetic layer formed thereon, a large volume of a magnetic recording medium can be manufactured at low cost. In contrast, it is difficult to produce a large volume of a magnetic recording medium at low cost when it is produced by a method in which a continuous web of a nonmagnetic support having a nonmagnetic layer and a magnetic layer formed thereon is once wound in roll form and again unrolled for forming a backcoat layer.

To secure good productivity, the moving speed of a nonmagnetic support on which each layer is formed is preferably at least 100 m/min, more preferably 200 m/min or higher, even more preferably 300 m/min or higher, most preferably 400 m/min or higher. Although a higher coating speed is more advantageous for productivity improvement, the upper limit of the coating speed is preferably 700 m/min because coating defects, such as streaks or nonuniformity, are liable to occur at too high a coating speed.

The magnetic coating composition applied to the nonmagnetic support is usually subjected to magnetic orientation treatment while it is wet to have the ferromagnetic powder oriented.

The ferromagnetic metal powder is preferably oriented in the machine direction using cobalt magnets or a solenoid. While hexagonal ferrite powder is liable to have in-plane and perpendicular, three-dimensional random orientation but could have in-plane two-dimensional random orientation. It is also possible to provide a magnetic layer in disk form with circumferentially isotropic magnetic characteristics by perpendicular orientation in a known manner, for example, by using facing magnets with their polarities opposite. Perpendicular orientation is preferred for high density recording.

Each of applied coating compositions is dried by, for example blowing hot air. The drying air temperature is preferably 60° C. or higher. The amount of drying air to be blown is decided according to the amount of the coating composition applied and the drying air temperature. The coating layer may be pre-dried before entering the magnet zone of orientation treatment.

After drying, the web having the nonmagnetic layer, magnetic layer, and backcoat layer is usually calendered to smoothen the magnetic layer side thereof. Calendering is carried out using metallic rolls or rolls of heat-resistant plastics, such as epoxy resins, polyimide, polyamide, and polyimide-amide. Calendering is preferably carried out at a temperature of 50° C. or higher, more preferably 90° C. or higher, under a linear pressure of 200 kg/cm (196 kN/m) or higher, more preferably 300 kg/cm (294 kN/m) or higher.

The resulting magnetic recording medium is usually subjected to heat treatment for the purposes of improving dimensional stability in the environment of use and accelerating cure of the coating layer containing a thermosetting curing agent. To improve productivity, the heat treatment is preferably performed by bulk-heating a magnetic recording medium of roll form on a core, more preferably before being slit to tape width.

The heat treatment temperature preferably ranges from 50° to 80° C., in which range the improvement of dimensional stability of the nonmagnetic support and cure acceleration of the curing agent are effectively achieved. The heat treatment temperature is adjusted as appropriate to the purpose.

The calendaring may be conducted either or both before and after the heat treatment.

The total residual solvent content in the magnetic layer, nonmagnetic layer, and backcoat layer is preferably 0.1 to 25 mg/g. If a magnetic recording medium with too much residual solvent is wound on a core or a cassette hub, the magnetic layer becomes soft by the action of the residual solvent and ready to be imprinted with the protrusions of the backcoat layer, resulting in an increase of depressions on the magnetic layer surface. Such an increase of depressions on the magnetic layer surface is particularly noticeable when the magnetic recording medium is heat treated in roll form. The total residual solvent content in the magnetic layer, nonmagnetic layer, and backcoat layer is more preferably 0.1 to 20 mg/g, even more preferably 0.1 to 10 mg/g. The residual solvent content is determined by a known gas chromatographic technique.

### EXAMPLES

The present invention will now be illustrated in greater detail with reference to Examples and Comparative Examples, but it should be understood that the invention is not construed as being limited thereto. Unless otherwise noted, all the parts are by mass.

### Example 1-1

### (1) Nonmagnetic Support

A commercially available polyethylene 2,6-naphthalate (PEN) film with a thickness of 5.0 μm was used.

### (2) Preparation of Coating Composition for Nonmagnetic Layer

The components of formulation 1 below were kneaded in a known open kneader and then dispersed in a known bead mill (e.g., Dynomill) using 0.5 mm diameter zirconia beads to prepare a dispersion of nonmagnetic particles.

### Formulation 1:

| | |
|---|---|
| Nonmagnetic powder α-Fe₂O₃ (acicular; BET specific | 80 parts |
| surface area: 52 m²/g; surface treating agent: Al₂O₃ | |
| and SiO₂; average length: 110 nm; pH: 9.0; tap | |
| density: 0.8 g/cc; DBP absorption: 27-38 g/100 g) | |
| Carbon black (BET specific surface area: 260 m²/g; DBP | 20 parts |
| absorption: 80 ml/100 g; pH: 7.5; volatile content: 1.5%) | |
| Polyvinyl chloride resin (MR-110, from Zeon Corp.) | 12 parts |
| Polyurethane resin (Mw: 35,000; branched side chain- | 7.5 parts |
| containing polyester polyol/diphenylmethane | |
| diisocyanate; -So₃Na group content: 70 eq/ton) | |
| Methyl ethyl ketone | 150 parts |
| Cyclohexanone | 150 parts |

To the dispersion were added the components of formulation 2 below, and the system was dispersed in a known ultrasonic disperser. The dispersion was filtered through a filer with an average pore size of 1.0 μm to prepare a coating composition for nonmagnetic layer.

### Formulation 2:

| | | |
|---|---|---|
| Polyisocyanate (Coronate L, from Nippon | 5 | parts |
| Polyurethane Industry Co. Ltd.) | | |
| Butyl stearate | 1.5 | parts |
| Stearic acid | 1 | part |
| Methyl ethyl ketone | 5 | parts |
| Cyclohexanone | 75 | parts |

### (3) Preparation of Magnetic Coating Composition for Magnetic Layer

Of the components of formulation 3 below, ferromagnetic metal powder, polyurethane resins PU1 and PU2 having the same molecular structure and different molecular weights, and polyvinyl chloride resin, methyl ethyl ketone, and cyclohexanone were kneaded in a known open kneader. Alpha-alumina and carbon black of formulation 3 were added thereto, followed by dispersing in a known bead mill containing 0.5 mm diameter zirconia beads to prepare a dispersion of ferromagnetic metal particles.

### Formulation 3:

| | | |
|---|---|---|
| Ferromagnetic metal powder (acicular; Fe/Co = 100/40; Hc: 186 kA/m | 100 | parts |
| (2350 Oe); BET specific surface area: 75 m²/g; | | |
| surface treating agent: Al₂O₃, SiO₂, and Y₂O₃; | | |
| average length: 35 nm; average aspect ratio: 3.6; σs; 106 A · m²/kg (106 emu/g); | | |
| Polyurethane resin PU1 (Mw: 170,000; polyester polyol/diphenylmethane | 6 | parts |
| diisocyanate; —SO₃Na content: 70 eq/ton) | | |
| Polyurethane resin PU2 (Mw: 80,000; polyester polyol/diphenylmethane | 6 | parts |
| diisocyanate; —SO₃Na content: 70 eq/ton) | | |
| Polyvinyl chloride resin (MR-110, from Zeon Corp) | 9 | parts |
| Alpha-alumina (average particle size: 0.1 μm; Mohs hardness: 9) | 3 | parts |
| Carbon black (specific surface area: 23 m²/g) | 0.3 | parts |
| Methyl ethyl ketone | 150 | parts |
| Cyclohexanone | 150 | part |

To the dispersion were added the components of formula 4 below, and the mixture was stirred and then dispersed in a known ultrasonic disperser, followed by filtration through a filter with an average pore size of 1.0 μm to prepare a coating composition for magnetic layer, which had a solids content of 15.0%.

### Formulation 4:

| | |
|---|---|
| Polyisocyanate (Coronate L, from Nippon | 4 parts |
| Polyurethane Industry Co. Ltd.) | |
| Butyl stearate | 1.5 parts |
| Stearic acid | 0.5 parts |
| Methyl ethyl ketone | 293 parts |
| Cyclohexanone | 145 parts |

### (4) Preparation of Coating Composition 1 for Backcoat Layer

The components of formulation 5 below, i.e., polymer particles A having a crosslinked structure in which the primary particles formed no aggregate (see Table 1), carbon black, α-alumina, nitrocellulose, polyurethane resin, and solvents were kneaded in a known manner and dispersed in a known bead mill using 0.5 mm diameter zirconia beads. In Table 1, the average primary particle size D50 is a diameter at 50% of the total sphere equivalent volume of about 1000 particles on an SEM image. The particle size distribution D25/D75 is a ratio of D25 (the diameter at 25% of the total volume cumulated from the largest particles) to D75 (the diameter at 75% of the total volume cumulated from the largest particles). The glass transition temperature Tg or the softening temperature Ts was measured with a commercially available differential scanning calorimeter DSC Q-200 from TA Instruments.

### Formulation 5:

| | |
|---|---|
| Carbon black (specific surface area: 220 m/g²) | 100 parts |
| Polymer particles A | 1.3 parts |
| Alpha-alumina (average particle size: 0.15 μm) | 0.5 parts |
| Nitrocellulose (from Bergerac NC) | 100 parts |
| Polyurethane resin (Mw: 40,000; polyester polyol/ | 43 parts |
| diphenylmethane diisocyanate; —SO₃Na group | |
| content: 65 eq/ton) | |
| Methyl ethyl ketone | 900 parts |
| Toluene | 900 parts |

To the dispersion were added the components of formula 6 below and stirred. The mixture was filtered through a filter with an average pore size of 1.0 μm to prepare coating composition 1 for backcoat layer.

### Formulation 6:

| | |
|---|---|
| Polyester resin (Vylon 500, from Toyobo) | 4 parts |
| Polyisocyanate (Coronate L, from Nippon Polyurethane) | 17 parts |

### (5) Making Magnetic Recording Medium

The coating composition for nonmagnetic layer was applied to a web of a nonmagnetic support (length: 10,000 m) to a dry thickness of 1.0 μm and dried at 110° C. in a known manner to form a nonmagnetic layer.

The coating composition for magnetic layer was applied to the nonmagnetic layer to a dry thickness of 0.06 μm by the method taught in JP 2003-236452A. While the magnetic coating layer was wet, it was subjected to orientation treatment using a cobalt magnet with a magnetic force of 0.5 T (5000 G) and a solenoid with a magnetic force of 0.4 T (4000 G) and dried at 120° C. to form a magnetic layer.

Coating composition 1 for backcoat layer was applied to the opposite side of the web to a dry thickness of 0.5 μm in a known manner and dried at 120° C. to form a backcoat layer.

The drying conditions of the nonmagnetic layer, the magnetic layer, and the backcoat layer were adjusted appropriately so that the total residual solvent content of these layers might be as shown in Table 4.

The coated web was calendered on a 7-roll calender having only metal rolls set at 95° C. under a linear pressure of 300 kg/cm at a speed of 150 m/min and slit to ½ inch width, and wound on a core into pancake form. The tape pancake was heat treated at 65° C. for 48 hours to make a magnetic recording tape.

### (6) Evaluation

The resulting magnetic tape was evaluated as follows. The results obtained are shown in Table 4.

### (i) The State of Existence of the Polymer Particles (=Degree of Structure)

The state of existence of polymer particles A in the backcoat layer was evaluated by observing 100 specimens on the surface and the cross-section of the backcoat layer under an SEM, and the degree of structure was rated A to C. In this regard, primary particle (including aggregate) and agglomerate were considered as minimum units so that each of one primary particle (including aggregate) and one agglomerate was counted as one specimen.

A: There are no aggregates nor agglomerates.
B: One or two aggregates or agglomerates are observed.
C: Three or more aggregates or agglomerates are observed.

### (ii) Surface Profile of Backcoat Layer

The surface profile of the backcoat layer was analyzed by AMP using Nanoscope IV (from Digital Instruments) equipped with a four-sided pyramidal SiN probe having a tip angle of 70° over a total assessment area of 0.1 mm² (10× sampling area of 0.01 mm²) to determine the centerline average surface roughness Ra and the number of protrusions of 100 nm or higher.

(iii) Surface Resistivity

The surface resistivity of the backcoat layer was determined using the electrodes illustrated in FIG. 1 of JP 2008-77698A. The magnetic tape was put over the electrodes (made of 24-carat gold) with its backcoat layer in contact with the electrodes, and a load of 1.62 N was applied to each end of the tape. A direct voltage of 100 V was applied between the electrodes, and the current was measured to calculate the surface resistivity.

### (iv) Residual Solvent Content

A 20 cm length of the magnetic tape (½ in. wide) was sealed in a sample bottle. The bottle was heated up to 150° C. and kept at that temperature for 10 minutes. The gas in the bottle was analyzed by gas chromatography using GC9A from Shimadzu Corp. equipped with a column SE-30 (column temperature: 100° C.; injection temperature: 150° C.) and a flame ionization detector to determine the total content of residual solvents (i.e., cyclohexanone, methyl ethyl ketone, and toluene).

The residual solvent content (mg/g) was obtained from the total mass of the nonmagnetic layer, the magnetic layer, and the backcoat layer of a sample using a previously prepared calibration curve. The total mass of the nonmagnetic layer, magnetic layer, and backcoat layer was obtained as a decrease in mass when these layers are removed from a sample with an appropriate solvent.

### (v) Number of Depressions on Magnetic Layer

The magnetic layer was examined by AFM using Nanoscope IV (from Digital Instruments) equipped with a four-sided pyramidal SiN probe having a tip angle of 70° over a total assessment area of 0.5 mm² (50×0.01 mm²) at a position 300 m from the trailing end of the heat treated tape pancake. The number of depressions with a circle equivalent diameter of 2.0 μm or greater and a depth of 60 nm or more was counted.

As far as the magnetic recording medium prepared in Examples is concerned, since the magnetic layer defines the outermost surface of the medium, the surface condition of the surface side in terms of the number of the depressions is equivalent to that of the magnetic layer.

### (vi) Running Properties

The running properties and wind quality of the magnetic tape during the production and on a drive system were evaluated and rated A to C.

A: Good running properties and wind quality.
B: Slightly poor running properties and wind quality.
C: Very poor running properties and wind quality.
(vii) Frequency of Dropout

The magnetic tape was recorded with signals at a linear recording density of 200 kfci over a length between 300 m and 400 m from the trailing end of the heat treated tape pancake. The signals were read with an MR head having a read track width of 4 μm and 2 μm, and the number of dropouts per meter was counted, the dropout being defined as a 70% or more reduction in output. The smaller the read track width is, the more liable a dropout is to occur even at a small circle-equivalent diameter and shallow depression. The frequency of the dropout occurrence was ranked as follows.

A: The frequency of dropout occurrence is less than 0.5 per meter.
B: The frequency of dropout occurrence is 0.5 or more and less than 1.0 per meter.
C: The frequency of dropout occurrence is 1.0 or more and less than 3.0 per meter.
D: The frequency of dropout occurrence is 4 or more per meter.

### Examples 1-2

### Preparation of Coating Composition 2 for Backcoat Layer

Coating composition 2 for backcoat layer was prepared in the same manner as for coating composition 1 of Example 1-1, except for replacing polymer particles A with polymer particles B (see Table 1). The amount of polymer particles B was adjusted so that the number of protrusions of 100 nm or higher on the backcoat layer after the calendering and before the heat treatment might be approximately the same as that on the backcoat layer of Example 1-1 after the calendering and before the heat treatment.

### Making and Evaluation of Magnetic Recording Medium:

A magnetic recording tape was made and evaluated in the same manner as in Example 1-1, except for changing the thickness of the backcoat layer to 0.6 μm.

### Example 1-3

### Preparation of Coating Composition 3 for Backcoat Layer

Coating composition 3 for backcoat layer was prepared in the same manner as for coating composition 1 of Example 1-1, except for replacing polymer particles A with polymer particles C (see Table 1). The amount of polymer particles C was adjusted in the same manner as in Example 1-2.

### Making and Evaluation of Magnetic Recording Medium:

A magnetic recording tape was made and evaluated in the same manner as in Example 1-1, except for changing the thickness of the backcoat layer to 0.7 μm.

### Example 1-4

### Preparation of Coating Composition 4 for Backcoat Layer

Coating composition 4 for backcoat layer was prepared in the same manner as for coating composition 1, except for replacing polymer particles A with polymer particles D (see Table 1). The amount of polymer particles D was adjusted in the same manner as in Example 1-2.

### Making and Evaluation of Magnetic Recording Medium:

A magnetic recording tape was made and evaluated in the same manner as in Example 1-1.

### Example 1-5

### Preparation of Coating Composition 5 for Backcoat Layer

Coating composition 5 for backcoat layer was prepared in the same manner as for coating composition 1, except for replacing polymer particles A with polymer particles E (see Table 1). The amount of polymer particles E was adjusted in the same manner as in Example 1-2.

### Making and Evaluation of Magnetic Recording Medium:

A magnetic recording tape was made and evaluated in the same manner as in Example 1-1, except for changing the thickness of the backcoat layer to 0.4 μM.

### Example 1-6

### Preparation of Coating Composition 6 for Backcoat Layer

Coating composition 6 for backcoat layer was prepared in the same manner as for coating composition 1, except for replacing polymer particles A with polymer particles F (see Table 1). The amount of polymer particles F was adjusted in the same manner as in Example 1-2.

### Making and Evaluation of Magnetic Recording Medium:

A magnetic recording tape was made and evaluated in the same manner as in Example 1-1, except for changing the thickness of the backcoat layer to 0.4 μm.

### Example 1-7

### Preparation of Coating Composition 7 for Backcoat Layer

Coating composition 7 for backcoat layer was prepared in the same manner as for coating composition 1, except for replacing polymer particles A with polymer particles G (see Table 1). The amount of polymer particles G was adjusted in the same manner as in Example 1-2.

### Making and Evaluation of Magnetic Recording Medium:

A magnetic recording tape was made and evaluated in the same manner as in Example 1-1, except for changing the thickness of the backcoat layer to 0.4 μm and changing the heat treatment temperature to 50° C.

### Example 1-8

### Preparation of Coating Composition 8 for Backcoat Layer

Coating composition 8 for backcoat layer was prepared in the same manner as for coating composition 1, except for replacing polymer particles A with polymer particles H (see Table 1). The amount of polymer particles H was adjusted in the same manner as in Example 1-2.

### Making and Evaluation of Magnetic Recording Medium:

A magnetic recording tape was made and evaluated in the same manner as in Example 1-1, except for changing the thickness of the backcoat layer to 0.3 μm and changing the heat treatment temperature to 60° C.

### Example 1-9

### Preparation of Coating Composition 9 for Backcoat Layer

Coating composition 9 for backcoat layer was prepared in the same manner as for coating composition 1, except for replacing polymer particles A with polymer particles I (see Table 1). The amount of polymer particles I was adjusted in the same manner as in Example 1-2.

### Making and Evaluation of Magnetic Recording Medium:

A magnetic recording tape was made and evaluated in the same manner as in Example 1-1.

### Example 1-10

### Preparation of Coating Composition 10 for Backcoat Layer

Coating composition 10 for backcoat layer was prepared in the same manner as for coating composition 1, except for replacing polymer particles A with polymer particles J (see Table 1). The amount of polymer particles J was adjusted in the same manner as in Example 1-2.

### Making and Evaluation of Magnetic Recording Medium:

A magnetic recording tape was made and evaluated in the same manner as in Example 1-1, except for changing the thickness of the backcoat layer to 0.4 μm.

### Example 1-11

### Preparation of Coating Composition 11 for Backcoat Layer

Coating composition 11 for backcoat layer was prepared in the same manner as for coating composition 1 of Example 1-1, except for replacing polymer particles A with polymer particles K (see Table 1). The amount of polymer particles K was adjusted in the same manner as in Example 1-2.

### Making and Evaluation of Magnetic Recording Medium:

A magnetic recording tape was made and evaluated in the same manner as in Example 1-1.

### Example 1-12

### Preparation of Coating Composition 12 for Backcoat Layer

Coating composition 12 for backcoat layer was prepared in the same manner as for coating composition 1, except for replacing polymer particles A with polymer particles L (see Table 1). The amount of polymer particles L was adjusted in the same manner as in Example 1-2.

### Making and Evaluation of Magnetic Recording Medium:

A magnetic recording tape was made and evaluated in the same manner as in Example 1-1.

### Example 1-13

### Preparation of Coating Composition 13 for Backcoat Layer

Coating composition 13 for backcoat layer was prepared in the same manner as for coating composition 1, except for replacing polymer particles A with polymer particles M (see Table 2). The amount of polymer particles M was adjusted in the same manner as in Example 1-2.

### Making and Evaluation of Magnetic Recording Medium:

A magnetic recording tape was made and evaluated in the same manner as in Example 1-1, except for changing the thickness of the backcoat layer to 0.7 μm.

### Example 1-14

### Preparation of Coating Composition 14 for Backcoat Layer

Coating composition 14 for backcoat layer was prepared in the same manner as for coating composition 1, except for replacing polymer particles A with polymer particles N (see Table 2). The amount of polymer particles N was adjusted in the same manner as in Example 1-2.

### Making and Evaluation of Magnetic Recording Medium:

A magnetic recording tape was made and evaluated in the same manner as in Example 1-1, except for changing the thickness of the backcoat layer to 0.7 μm.

### Example 1-15

### Preparation of Coating Composition 15 for Backcoat Layer

Coating composition 15 for backcoat layer was prepared in the same manner as for coating composition 1, except for replacing polymer particles A with polymer particles O (see Table 2). The amount of polymer particles O was adjusted in the same manner as in Example 1-2.

### Making and Evaluation of Magnetic Recording Medium:

A magnetic recording tape was made and evaluated in the same manner as in Example 1-1, except for changing the thickness of the backcoat layer to 0.7 μm.

### Example 1-16

### Preparation of Coating Composition 16 for Backcoat Layer

Coating composition 16 for backcoat layer was prepared in the same manner as for coating composition 1, except for replacing polymer particles A with polymer particles P (see Table 2). The amount of polymer particles P was adjusted in the same manner as in Example 1-2.

### Making and Evaluation of Magnetic Recording Medium:

A magnetic recording tape was made and evaluated in the same manner as in Example 1-1, except for changing the thickness of the backcoat layer to 0.7 μm.

### Example 1-17

### Preparation of Coating Composition 17 for Backcoat Layer

Coating composition 17 for backcoat layer was prepared in the same manner as for coating composition 1, except for replacing polymer particles A with polymer particles Q (see Table 2). The amount of polymer particles Q was adjusted in the same manner as in Example 1-2.

### Making and Evaluation of Magnetic Recording Medium:

A magnetic recording tape was made and evaluated in the same manner as in Example 1-1, except for changing the thickness of the backcoat layer to 0.7 μm.

### Example 1-18

### Preparation of Coating Composition 18 for Backcoat Layer

Coating composition 18 for backcoat layer was prepared in the same manner as for coating composition 1, except for replacing polymer particles A with polymer particles R (see Table 2). The amount of polymer particles R was adjusted in the same manner as in Example 1-2.

### Making and Evaluation of Magnetic Recording Medium:

A magnetic recording tape was made and evaluated in the same manner as in Example 1-1, except for changing the thickness of the backcoat layer to 0.7 μm.

### Example 1-19

### Preparation of Coating Composition 19 for Backcoat Layer

Coating composition 19 for backcoat layer was prepared in the same manner as for coating composition 1, except for replacing polymer particles A with polymer particles S (see Table 2). The amount of polymer particles S was adjusted in the same manner as in Example 1-2.

### Making and Evaluation of Magnetic Recording Medium:

A magnetic recording tape was made and evaluated in the same manner as in Example 1-1, except for changing the thickness of the backcoat layer to 0.7 μm and changing the heat treatment temperature to 60° C.

### Example 1-20

### Preparation of Coating Composition 20 for Backcoat Layer

Coating composition 20 for backcoat layer was prepared in the same manner as for coating composition 1, except for replacing polymer particles A with polymer particles T (see Table 2). The amount of polymer particles T was adjusted in the same manner as in Example 1-2.

### Making and Evaluation of Magnetic Recording Medium:

A magnetic recording tape was made and evaluated in the same manner as in Example 1-1, except for changing the thickness of the backcoat layer to 0.7 μm and changing the heat treatment temperature to 55° C.

### Example 1-21

### Preparation of Coating Composition 21 for Backcoat Layer

Coating composition 21 for backcoat layer was prepared in the same manner as for coating composition 1, except for replacing polymer particles A with polymer particles U (see Table 2). The polymer particles U had their average primary particle size D50 and particle size distribution D25/D75 adjusted by using a known wet classifier.

### Making and Evaluation of Magnetic Recording Medium:

A magnetic recording tape was made and evaluated in the same manner as in Example 1-1, except for changing the thickness of the backcoat layer to 0.7 μm.

### Example 1-22

### Preparation of Coating Composition 22 for Backcoat Layer

Coating composition 22 for backcoat layer was prepared in the same manner as for coating composition 1, except for replacing polymer particles A with inorganic particles a (see Table 2). The amount of inorganic particles a was adjusted in the same manner as in Example 1-2.

### Making and Evaluation of Magnetic Recording Medium:

A magnetic recording tape was made and evaluated in the same manner as in Example 1-1.

### Example 1-23

### Preparation of Coating Composition 23 for Backcoat Layer

Coating composition 23 for backcoat layer was prepared in the same manner as for coating composition 1, except for replacing polymer particles A with inorganic particles b (see Table 2). The amount of inorganic particles b was adjusted in the same manner as in Example 1-2.

### Making and Evaluation of Magnetic Recording Medium:

A magnetic recording tape was made and evaluated in the same manner as in Example 1-1, except for changing the thickness of the backcoat layer to 0.6 μm.

### Example 1-24

### Preparation of Coating Composition 24 for Backcoat Layer

Coating composition 24 for backcoat layer was prepared in the same mariner as for coating composition 1, except for replacing polymer particles A with inorganic particles c (see Table 2). The amount of inorganic particles c was adjusted in the same manner as in Example 1-2.

### Making and Evaluation of Magnetic Recording Medium:

A magnetic recording tape was made and evaluated in the same manner as in Example 1-1, except for changing the thickness of the backcoat layer to 0.3 μm.

### Example 1-25

### Preparation of Coating Composition 25 for Backcoat Layer

Coating composition 25 for backcoat layer was prepared in the same manner as for coating composition 1, except for replacing polymer particles A with inorganic particles d (see Table 2). The inorganic particles d was obtained by a known thermal spraying method and had their average primary particle size D50 and particle size distribution D25/D75 adjusted by using a known wet classifier. The amount of inorganic particles d was adjusted in the same manner as in Example 1-2.

### Making and Evaluation of Magnetic Recording Medium:

A magnetic recording tape was made and evaluated in the same manner as in Example 1-1.

### Example 1-26

### Preparation of Coating Composition 26 for Backcoat Layer

Coating composition 26 for backcoat layer was prepared in the same manner as for coating composition 1, except for replacing the carbon black having a specific surface area of 220 m²/g with carbon black with a specific surface area of 85 m²/g.

Making and Evaluation of Magnetic Recording Medium:

A magnetic recording tape was made and evaluated in the same manner as in Example 14.

### Example 1-27

### Preparation of Coating Composition 27 for Backcoat Layer

Coating composition 27 for backcoat layer was prepared in the same manner as for coating composition 1, except for replacing the carbon black having a specific surface area of 220 m²/g with carbon black with a specific surface area of 51 m²/g.

Making and Evaluation of Magnetic Recording Medium:

A magnetic recording tape was made and evaluated in the same manner as in Example 1-1.

### Example 1-28

### Preparation of Coating Composition 28 for Backcoat Layer

Coating composition 28 for backcoat layer was prepared in the same manner as for coating composition 1, except for replacing the carbon black having a specific surface area of 220 m²/g with carbon black with a specific surface area of 38 m²/g.

Making and Evaluation of Magnetic Recording Medium:

A magnetic recording tape was made and evaluated in the same manner as in Example 1-1.

### Example 1-29

A magnetic recording tape was made and evaluated in the same manner as in Example 1-1, except that the drying conditions for the nonmagnetic layer and the magnetic layer were adjusted so that the total residual content in the nonmagnetic layer, magnetic layer, and backcoat layer might be 12 mg/g.

### Example 1-30

A magnetic recording tape was made and evaluated in the same manner as in Example 1-1, except that the drying conditions for the nonmagnetic layer and the magnetic layer were adjusted so that the total residual content in the nonmagnetic layer, magnetic layer, and backcoat layer might be 21 mg/g.

### Comparative Example 1-A

### Preparation of Coating Composition 29 for Backcoat Layer

Coating composition 29 for backcoat layer was prepared in the same manner as for coating composition 1, except for replacing polymer particles A with polymer particles V (see Table 3). The amount of polymer particles V was adjusted in the same manner as in Example 1-2.

### Making and Evaluation of Magnetic Recording Medium:

A magnetic recording tape was made and evaluated in the same manner as in Example 1-1.

### Comparative Example 1-B

### Preparation of Coating Composition 30 for Backcoat Layer

Coating composition 30 for backcoat layer was prepared in the same manner as for coating composition 1, except for replacing polymer particles A with polymer particles W (see Table 3). The amount of polymer particles W was adjusted in the same manner as in Example 1-2.

### Making and Evaluation of Magnetic Recording Medium:

A magnetic recording tape was made and evaluated in the same manner as in Example 1-1.

### Comparative Example 1-C

### Preparation of Coating Composition 31 for Backcoat Layer

Coating composition 31 for backcoat layer was prepared in the same manner as for coating composition 1, except for replacing polymer particles A with inorganic particles e (see Table 3). The amount of inorganic particles e was adjusted in the same manner as in Example 1-2.

### Making and Evaluation of Magnetic Recording Medium:

A magnetic recording tape was made and evaluated in the same manner as in Example 1-1.

### Comparative Example 1-D

### Preparation of Coating Composition 32 for Backcoat Layer

Coating composition 32 for backcoat layer was prepared in the same manner as for coating composition 1, except for replacing polymer particles A with polymer particles X (see Table 3) having a crosslinked structure and having aggregates composed of primary particles of about 0.3 μm. The amount of polymer particles X was adjusted in the same manner as in Example 1-2.

### Making and Evaluation of Magnetic Recording Medium:

A magnetic recording tape was made and evaluated in the same manner as in Example 1-1.

### Comparative Example 1-E

### Preparation of Coating Composition 33 for Backcoat Layer

Coating composition 33 for backcoat layer was prepared in the same manner as for coating composition 1, except for replacing polymer particles A with inorganic particles f having aggregates of primary particles (carbon black; specific surface area: 15 m²/g, see Table 3). The amount of inorganic particles f was adjusted in the same manner as in Example 1-2.

### Making and Evaluation of Magnetic Recording Medium:

A magnetic recording tape was made and evaluated in the same manner as in Example 1-1.

### Comparative Example 1-F

### Preparation of Coating Composition 34 for Backcoat Layer

Coating composition 34 for backcoat layer was prepared in the same manner as for coating composition 1, except for replacing polymer particles A with inorganic particles g having aggregates of primary particles (carbon black; specific surface area: 8 m²/g, see Table 3). The amount of inorganic particles g was adjusted in the same manner as in Example 1-2.

### Making and Evaluation of Magnetic Recording Medium:

A magnetic recording tape was made and evaluated in the same manner as in Example 1-1.

### Comparative Example 1-G

### Preparation of Coating Composition 35 for Backcoat Layer

Coating composition 35 for backcoat layer was prepared in the same manner as for coating composition 1, except for replacing polymer particles A with inorganic particles h having aggregates of primary particles (colloidal silica having a three-dimensional structure obtained by gelation of silicic acid, see Table 3). The amount of inorganic particles h was adjusted in the same manner as in Example 1-2.

### Making and Evaluation of Magnetic Recording Medium:

A magnetic recording tape was made and evaluated in the same manner as in Example 1-1.

### Comparative Example 1-H

### Preparation of Coating Composition 36 for Backcoat Layer

Coating composition 36 for backcoat layer was prepared in the same manner as for coating composition 1, except that polymer particles A were not used.

### Making and Evaluation of Magnetic Recording Medium:

A magnetic recording tape was made and evaluated in the same manner as in Example 1-1.

TABLE 1

| Coating | | | | | | | |
|---|---|---|---|---|---|---|---|
| Composition | Particles | | | | | | |
| No. | No. | Kind | Components | Shape | D50 (μm) | D25/D75 | Tg or Ts (° C.) |
| 1 | A | crosslinked | divinylbenzene-ethylvinylbenzene- | spherical | 0.31 | 1.15 | 108 |
| | | polymer particles | methacrylic acid-styrene-thermoplastic | (no | | | |
| | | | polymer modified copolymer | aggregate) | | | |
| 2 | B | crosslinked | methyl methacrylate-divinylbenzene- | spherical | 0.48 | 1.10 | 142 |
| | | polymer particles | ethylvinylbenzene-methacrylic acid-styrene- | (no | | | |
| | | | thermoplastic polymer modified copolymer | aggregate) | | | |
| 3 | C | crosslinked | divinylbenzene-ethylvinylbenzene- | spherical | 0.59 | 1.07 | 90 |
| | | polymer particles | methacrylic acid-styrene-thermoplastic | (no | | | |
| | | | polymer modified copolymer | aggregate) | | | |
| 4 | D | crosslinked | methacrylic ester copolymer | spherical | 0.38 | 1.25 | 101 |
| | | polymer particles | | (no | | | |
| | | | | aggregate) | | | |
| 5 | E | crosslinked | ″ | spherical | 0.22 | 1.35 | 144 |
| | | polymer particles | | (no | | | |
| | | | | aggregate) | | | |
| 6 | F | crosslinked | methacrylic ester-thermoplastic polymer | spherical | 0.25 | 1.25 | 95 |
| | | polymer particles | modified copolymer | (no | | | |
| | | | | aggregate) | | | |
| 7 | G | crosslinked | styrene-butadiene copolymer | spherical | 0.22 | 1.25 | 58 |
| | | polymer particles | | (no | | | |
| | | | | aggregate) | | | |
| 8 | H | crosslinked | methacrylic ester-acrylonitrile-styrene | spherical | 0.15 | 1.35 | 70 |
| | | polymer particles | copolymer | (no | | | |
| | | | | aggregate) | | | |
| 9 | I | polymer particles | Fluoropolymer | spherical | 0.32 | 1.85 | 130 |
| | | | | (no | | | |
| | | | | aggregate) | | | |
| 10 | J | crosslinked | melamine-formaldehyde condensate | spherical | 0.23 | 1.75 | undetected |
| | | polymer particles | | (no | | | |
| | | | | aggregate) | | | |
| 11 | K | crosslinked | ″ | spherical | 0.42 | 1.65 | undetected |
| | | polymer particles | | (no | | | |
| | | | | aggregate) | | | |
| 12 | L | crosslinked | methacrylic acid-styrene-thermoplastic | spherical | 0.29 | 2.10 | 112 |
| | | polymer particles | polymer modified copolymer | (no | | | |
| | | | | aggregate) | | | |

TABLE 2

| Coating | Particles | | | | | | |
|---|---|---|---|---|---|---|---|
| Composition | | | | | | | Tg or Ts |
| No. | No. | Kind | Components | Shape | D50 (μm) | D25/D75 | (° C.) |
| 13 | M | crosslinked | methacrylic ester copolymer | spherical (no | 0.55 | 1.06 | 155 |
| | | polymer particles | | aggregate) | | | |
| 14 | N | crosslinked | methacrylic ester-thermoplastic | spherical (no | 0.56 | 1.05 | 125 |
| | | polymer particles | polymer modified copolymer | aggregate) | | | |
| 15 | O | crosslinked | methacrylic ester-thermoplastic | spherical (no | 0.53 | 1.06 | 95 |
| | | polymer particles | polymer modified copolymer | aggregate) | | | |
| 16 | P | crosslinked | methacrylic ester-thermoplastic | spherical (no | 0.55 | 1.05 | 50 |
| | | polymer particles | polymer modified copolymer | aggregate) | | | |
| 17 | Q | crosslinked | methacrylic ester-thermoplastic | spherical (no | 0.55 | 1.06 | 30 |
| | | polymer particles | modified copolymer | aggregate) | | | |
| 18 | R | crosslinked | methacrylic ester-thermoplastic | spherical (no | 0.65 | 1.15 | 90 |
| | | polymer particles | | aggregate) | | | |
| 19 | S | crosslinked | methacrylic ester copolymer | spherical (no | 0.72 | 1.10 | 70 |
| | | polymer particles | | aggregate) | | | |
| 20 | T | crosslinked | ″ | spherical (no | 0.85 | 1.05 | 65 |
| | | polymer particles | | aggregate) | | | |
| 21 | U | crosslinked | ″ | discotic (no | disc | 1.55 | 102 |
| | | polymer particles | | aggregate) | diameter = | (disc | |
| | | | | | 0.75; disc | diameter) | |
| | | | | | axis | | |
| | | | | | length = 0.41 | | |
| 22 | a | inorganic | silicon dioxide | spherical (no | 0.32 | 1.07 | — |
| | | particles | | aggregate) | | | |
| 23 | b | inorganic | ″ | spherical (no | 0.52 | 1.05 | — |
| | | particles | | aggregate) | | | |
| 24 | c | inorganic | ″ | spherical (no | 0.15 | 1.22 | — |
| | | particles | | aggregate) | | | |
| 25 | d | inorganic | Alumina | spherical (no | 0.32 | 1.54 | — |
| | | particles | | aggregate) | | | |

TABLE 3

| Coating | Particles | | | | | | |
|---|---|---|---|---|---|---|---|
| Composition | | | | | | | Tg or Ts |
| No. | No. | Kind | Components | Shape | D50 (μm) | D25/D75 | (° C.) |
| 26 | A | crosslinked | divinylbenzene-ethylvinylbenzene- | spherical (no | 0.31 | 1.15 | 108 |
| | | polymer particles | methacrylic acid-styrene-thermoplastic | aggregate) | | | |
| | | | polymer modified copolymer | | | | |
| 27 | A | crosslinked | divinylbenzene-ethylvinylbenzene- | spherical (no | 0.31 | 1.15 | 108 |
| | | polymer particles | methacrylic acid-styrene-thermoplastic | aggregate) | | | |
| | | | polymer modified copolymer | | | | |
| 28 | A | crosslinked | divinylbenzene-ethylvinylbenzene- | spherical (no | 0.31 | 1.15 | 108 |
| | | polymer particles | methacrylic acid-styrene-thermoplastic | aggregate) | | | |
| | | | polymer modified copolymer | | | | |
| 29 | V | crosslinked | Polystyrene | spherical (no | 1.52 | 1.05 | 140 |
| | | polymer particles | | aggregate) | | | |
| 30 | W | crosslinked | acrylic ester copolymer | spherical (no | 1.30 | 1.15 | 115 |
| | | polymer particles | | aggregate) | | | |
| 31 | e | inorganic | silicon dioxide | spherical (no | 1.31 | 1.03 | — |
| | | particles | | aggregate) | | | |
| 32 | X | crosslinked | acrylic ester copolymer-thermoplastic | amorphous | — | — | 85 |
| | | polymer particles | polymer modified copolymer | (with aggregate) | | | |
| 33 | f | inorganic | carbon black | amorphous | — | — | — |
| | | particles | | (with aggregate) | | | |
| 34 | g | inorganic | ″ | amorphous | — | — | — |
| | | particles | | (with aggregate) | | | |
| 35 | h | inorganic | silicon dioxide | amorphous | — | — | — |
| | | particles | | (with aggregate) | | | |
| 36 | — | — | — | — | — | — | — |

TABLE 4

| | | | | | | | Magnetic | | | |
|---|---|---|---|---|---|---|---|---|---|---|
| | Backcoat Layer | | | | | Residual | Layer/ | | Frequency | |
| | Coating | | | Number of | Surface | Solvent | Number of | | of | |
| Example | Composition | Degree of | | Protrusions | Resistivity | Content | Depressions | Running | Dropout | |
| No. | No. | Structure | Ra (nm) | (/0.1 mm²) | (Ω/sq) | (mg/g) | (/0.5 mm²) | Properties | 4 μm | 2 μm |
| 1-1 | 1 | A | 13.7 | 53 | 2.1 × 10⁶ | 3 | 1 | A | A | A |
| 1-2 | 2 | A | 14.7 | 47 | 2.5 × 10⁶ | 3 | 2 | A | A | A |
| 1-3 | 3 | A | 15.5 | 51 | 2.6 × 10⁶ | 4 | 2 | A | A | A |
| 1-4 | 4 | A | 13.2 | 48 | 2.1 × 10⁶ | 3 | 1 | A | A | A |
| 1-5 | 5 | A | 12.9 | 53 | 2.2 × 10⁶ | 3 | 1 | A | A | A |
| 1-6 | 6 | A | 12.7 | 48 | 2.2 × 10⁶ | 2 | 1 | A | A | A |
| 1-7 | 7 | B | 12.6 | 51 | 2.2 × 10⁶ | 5 | 1 | A | A | A |
| 1-8 | 8 | B | 12.5 | 52 | 2.1 × 10⁶ | 3 | 1 | A | A | A |
| 1-9 | 9 | B | 14.5 | 47 | 2.5 × 10⁶ | 3 | 6 | A | B | C |
| 1-10 | 10 | A | 14.0 | 52 | 2.4 × 10⁶ | 3 | 4 | A | A | B |
| 1-11 | 11 | A | 14.5 | 55 | 2.5 × 10⁶ | 2 | 6 | A | B | C |
| 1-12 | 12 | A | 13.9 | 55 | 2.4 × 10⁶ | 5 | 7 | A | B | C |
| 1-13 | 13 | A | 15.6 | 53 | 2.5 × 10⁶ | 3 | 7 | A | B | C |
| 1-14 | 14 | A | 15.5 | 54 | 2.6 × 10⁶ | 4 | 4 | A | A | B |
| 1-15 | 15 | A | 15.5 | 51 | 2.4 × 10⁶ | 5 | 2 | A | A | A |
| 1-16 | 16 | A | 15.3 | 52 | 2.6 × 10⁶ | 5 | 2 | A | A | A |
| 1-17 | 17 | A | 15.2 | 53 | 2.7 × 10⁶ | 4 | 1 | B | A | A |
| 1-18 | 18 | A | 15.7 | 51 | 2.6 × 10⁶ | 4 | 4 | A | A | B |
| 1-19 | 19 | A | 16.1 | 50 | 2.6 × 10⁶ | 2 | 5 | A | B | C |
| 1-20 | 20 | A | 16.5 | 52 | 2.8 × 10⁶ | 3 | 7 | A | B | C |
| 1-21 | 21 | B | 15.4 | 51 | 2.6 × 10⁶ | 4 | 10 | A | C | D |
| 1-22 | 22 | A | 13.4 | 50 | 2.2 × 10⁶ | 2 | 3 | A | A | B |
| 1-23 | 23 | A | 14.5 | 49 | 2.5 × 10⁶ | 2 | 6 | A | B | C |
| 1-24 | 24 | A | 12.5 | 49 | 2.2 × 10⁶ | 2 | 2 | A | A | A |
| 1-25 | 25 | A | 14.2 | 54 | 2.5 × 10⁶ | 3 | 7 | A | B | C |
| 1-26 | 26 | A | 16.2 | 48 | 2.1 × 10⁶ | 2 | 4 | A | A | B |
| 1-27 | 27 | A | 18.6 | 50 | 4.3 × 10⁶ | 3 | 9 | A | B | C |
| 1-28 | 28 | A | 19.8 | 52 | 7.5 × 10⁶ | 3 | 13 | A | C | D |
| 1-29 | 1 | A | 13.7 | 51 | 2.1 × 10⁶ | 12 | 4 | A | A | B |
| 1-30 | 1 | A | 13.6 | 50 | 2.2 × 10⁶ | 21 | 6 | A | B | C |

TABLE 5

| | | | | | | | Magnetic | | | |
|---|---|---|---|---|---|---|---|---|---|---|
| | Backcoat Layer | | | | | Residual | Layer | | Frequency | |
| Comparative | Coating | | | Number of | Surface | Solvent | Number of | | of | |
| Example | Composition | Degree of | | Protrusions | Resistivity | Content | Depressions | Running | Dropout | |
| No. | No. | Structure | Ra (nm) | (/0.1 mm²) | (Ω/sq) | (mg/g) | (/0.5 mm²) | Properties | 4 μm | 2 μm |
| 1-A | 29 | A | 18.5 | 55 | 3.2 × 10⁶ | 3 | 18 | A | D | D |
| 1-B | 30 | A | 17.3 | 52 | 2.9 × 10⁶ | 3 | 15 | A | D | D |
| 1-C | 31 | A | 17.4 | 49 | 3.1 × 10⁶ | 2 | 17 | A | D | D |
| 1-D | 32 | C | 16.3 | 51 | 2.7 × 10⁶ | 3 | 24 | A | D | D |
| 1-E | 33 | C | 14.5 | 52 | 0.7 × 10⁶ | 3 | 23 | A | D | D |
| 1-F | 34 | C | 16.2 | 50 | 0.9 × 10⁶ | 2 | 27 | A | D | D |
| 1-G | 35 | C | 17.1 | 49 | 2.8 × 10⁶ | 4 | 35 | A | D | D |
| 1-H | 36 | — | 12.0 | 2 | 2.3 × 10⁶ | 2 | 0 | C | A | A |

Examples 1-1 through 1-30 provided magnetic recording tapes exhibiting good running properties and reduced dropout errors.

Although the tapes of Comparative Examples 1-A to 1-G exhibited good running properties, they suffered from increased occurrence of dropout. The increase in dropout frequency in Comparative Examples 1-A to 1-C is believed to be because the particles used in the backcoat layer, while forming substantially no aggregates or agglomerates in the backcoat layer, had an average primary particle size D50 larger than 1.0 μm and therefore formed large protrusions that were imprinted on the magnetic layer to form depressions. The increase in dropout frequency in Comparative Examples 1-D to 1-G is considered to be because the particles formed aggregates or agglomerates in the backcoat layer to form large protrusions that were imprinted on the magnetic layer.

In Comparative Example 1-H, although the frequency of dropout was low, absence of particles that would form adequate protrusions on the backcoat layer surface allowed air to be entrained during winding, resulting in poor wind quality.

The reason the frequency of dropout errors in Examples 1-9 to 1-12 was somewhat higher than in Examples 1-1 to 1-8 is believed to be that the particles used in the former had a slightly larger particle size distribution D25/D75 and therefore formed more protrusions that were imprinted to the magnetic layer to form depressions causing dropouts.

In Examples 1-13 to 1-17, the depressions on the magnetic layer surface and dropouts reduced with a decrease in glass transition temperature of the polymer particles. This is considered to be because the polymer particles were softened and caused less formation of depressions during the heat treatment of the tape. In Example 1-17, the handling properties of the web in application and drying the coating compositions and calendering were slightly poor due to the slightly too low glass transition temperature of the polymer particles.

The reason the frequency of dropouts in Examples 1-18 to 1-20 was somewhat higher than in Examples 1-1 to 1-8 is believed to be that the particles used in the former had a slightly larger average primary particle size D50 and therefore formed more protrusions that were imprinted to the magnetic layer to form depressions causing dropouts.

The reason the frequency of dropout errors in Example 1-21 was somewhat higher than in Examples 1-1 to 1-8 is believed to be that the particles used in the former were not spherical and had a slightly larger particle size distribution D25/D75 and therefore formed more protrusions that were imprinted to the magnetic layer to form depressions causing dropouts.

The higher frequency of dropout in Examples 1-22 to 1-25 than in Examples 1-1 to 1-8 is ascribable to the fact that the inorganic particles used in the former had no thermoplasticity of the polymer particles used in the latter. That is, the pressure exerted by the non-thermoplastic particles to the magnetic layer does not reduce during the heat treatment, resulting in the formation of slightly more depressions causing dropouts.

The frequency of dropout increased as the specific surface area of the carbon black used in the backcoat layer decreases in Examples 1-26 to 1-28 as compared with Example 1-1. This is attributable to the fact that the carbon black with a smaller specific surface area has a higher degree of structure in the backcoat layer and forms slightly more protrusions causing dropout errors. Accordingly, it is proved preferred not to use carbon black with a specific surface area less than 30 m²/g.

The frequency of dropout increased as the residual solvent content of the magnetic recording medium increased in Examples 1-29 and 1-30 as compared with Example 1-1. It is considered that the magnetic layer becomes soft under the influence of the residual solvent during the heat treatment and more susceptible to back imprinting of the protrusions on the backcoat layer. It is thus proved necessary to adequately control the residual solvent content of the magnetic recording medium.

### Example 2

Magnetic recording tapes were made and evaluated in the same manner as in Examples 1-1 through 1-30 and Comparative Examples 1-A through 1-H, except for replacing the acicular ferromagnetic metal powder used in the magnetic layer with tabular ferromagnetic hexagonal ferrite powder below.

### Ferromagnetic Hexagonal Ferrite Powder (Tabular Particles):

Composition: Ba/Fe/Co/Zn=10/90/2/8 by mole

Coercive force Hc: 191 kA/m

BET specific surface area: 50 m²/g

Tabular diameter: 30 nm

Aspect ratio: 3

Saturation magnetization σs: 60 A·m²/kg

The results of evaluation were equal to those obtained in Examples 1-1 to 1-30 and Comparative Examples 1-A to 1-H. It has now been confirmed that the invention is effective as well in using ferromagnetic hexagonal ferrite powder in place of the ferromagnetic metal powder. It was also found that replacement with the ferromagnetic hexagonal ferrite powder provides magnetic recording media with further increased recording capacity and density.

### Example 3-1

### (1) Nonmagnetic Support

A commercially available polyethylene 2,6-naphthalate (PEN) film with a thickness of 4.5 μm was used.

### (2) Preparation of Coating Composition for Nonmagnetic Layer

The components of formulation 7 below were kneaded in a known open kneader and then dispersed in a known bead mill (e.g., Dynomill) using 0.5 mm diameter zirconia beads to prepare a dispersion of nonmagnetic particles.

### Formulation 7:

| | |
|---|---|
| Nonmagnetic powder α-Fe₂O₃ (acicular; BET specific | 75 parts |
| surface area: 60 m²/g; surface treating agent: Al₂O₃ | |
| and SiO₂; average length: 100 nm; pH: 9.0) | |
| Carbon black (BET specific surface area: 260 m²/g; DBP | 25 parts |
| absorption: 80 ml/100 g; pH: 7.5; volatile content: 1.5%) | |
| Polyvinyl chloride resin (MR 104, from Zeon Corp.) | 12 parts |
| Polyurethane resin (Mw: 35,000; branched side chain- | 7 parts |
| containing polyester polyol/diphenylmethane | |
| diisocyanate; -So₃Na group content: 70 eq/ton) | |
| Methyl ethyl ketone | 150 parts |
| Cyclohexanone | 150 parts |

To the dispersion were added the components of formulation 8 below, and the system was dispersed in a known ultrasonic disperser. The dispersion was filtered through a filer with an average pore size of 1.0 μm to prepare a coating composition for nonmagnetic layer.

### Formulation 8:

| | | |
|---|---|---|
| Polyisocyanate (Coronate L, from Nippon | 2 | parts |
| Polyurethane Industry Co. Ltd.) | | |
| Butyl stearate | 1.5 | parts |
| Stearic acid | 1 | part |
| Methyl ethyl ketone | 5 | parts |
| Cyclohexanone | 75 | parts |

### (3) Preparation of Magnetic Coating Composition for Magnetic Layer

Of the components of formulation 9 below, ferromagnetic hexagonal ferrite powder, polyvinyl chloride resin, polyurethane resin, methyl ethyl ketone, and cyclohexanone were kneaded in a known open kneader. Alpha-alumina and carbon black of formulation 9 were added thereto, followed by dispersing in a known bead mill containing 0.3 mm diameter zirconia beads to prepare a dispersion of ferromagnetic hexagonal ferrite powder.

### Formulation 9:

| | | |
|---|---|---|
| Ferromagnetic hexagonal ferrite powder (tabular; Ba/Fe/Co/Zn = 10/90/2/8 by mole; | 100 | parts |
| Hc: 176 kA/m (2200 Oe); BET specific surface area: 65 m²/g; average tabular | | |
| diameter: 20 nm; average aspect ratio: 3; σs: 49 A · m²/kg (49 emu/g); pH 7.0) | | |
| Polyvinyl chloride resin (MR 104, from Zeon Corp) | 10 | parts |
| Polyurethane resin (Mw: 70,000; polyester polyol/diphenylmethane | 4 | parts |
| diisocyanate; —SO₃Na content: 70 eq/ton) | | |
| Alpha-alumina (average particle size: 0.1 μm; Mohs hardness: 9) | 5 | parts |
| Carbon black (specific surface area: 23 m²/g) | 0.3 | parts |
| Methyl ethyl ketone | 150 | parts |
| Cyclohexanone | 150 | part |

To the dispersion were added the components of formula 10 below, and the mixture was stirred and then dispersed in a known ultrasonic disperser, followed by filtration through a filter with an average pore size of 1.0 μm to prepare a coating composition for magnetic layer.

### Formulation 10:

| | |
|---|---|
| Polyisocyanate (Coronate L, from Nippon | 2 parts |
| Polyurethane Industry Co., Ltd.) | |
| Butyl stearate | 1.5 parts |
| Stearic acid | 0.5 parts |
| Methyl ethyl ketone | 340 parts |
| Cyclohexanone | 180 parts |

### (4) Preparation of Polymer Particles Y-1

A 5-liter reaction vessel was charged with 97 parts of styrene, 3 parts of methacrylic acid, 0.5 parts of α-methylstyrene dimer, 5 parts of t-dodecylmercaptan, 0.8 parts of sodium dodecylbenzenesulfonate, 0.3 parts of potassium persulfate, and 250 parts of water. The reaction system was heated to 80° C. while stirring in a nitrogen gas atmosphere to conduct polymerization over a period of 7 hours to make a seed polymer, which was found to have an average primary particle size D50 of 0.16 μm and a particle size distribution D25/D75 of 1.07. To 10 parts, on solid basis, of the seed polymer were added and mixed 1.2 parts of sodium dodecylbenzenesulfonate, 1.0 part of polyoxyethylene-1-(acryloxymethyl) alkyl ether sulfuric ester ammonium salt, 0.6 parts of potassium persulfate, 600 parts of water, and 125 parts of divinylbenzene (marketed product; purity: 55%, with the balance being monofunctional vinyl monomer), and the seed particles were allowed to adsorb the monomer while stirring at 30° C. for 15 minutes. The system temperature was then raised to 80° C., at which polymerization was performed for 4 hours. The reaction system was filtered through a filter with an average pore size of 1.0 μm to remove foreign matter to obtain an aqueous dispersion of polymer particles.

The polymer particles were collected from the resulting aqueous dispersion using a known centrifugal separator. The polymer particles were re-dispersed in water by stirring and ultrasonication and then collected using a centrifugal separator. The re-dispersing and subsequent centrifugal separation were repeated three times to wash the polymer particles. The finally collected polymer particles were dried to remove water and pulverized using a known technique to give polymer particles having a crosslinked structure and forming no aggregates or agglomerates, designated Y-1 (see Table 6). The polymer particles Y-1 had an average primary particle size D50 of 0.3 μm and a size distribution D25/D75 of 1.03. An SEM image of the polymer particles Y-1 is shown in the Drawing.

### (5) Preparation of Coating Composition I for Backcoat Layer

The components of formulation 11 below were dispersed in a known bead mill using 0.5 mm diameter zirconia beads.

### Formulation 11:

| | |
|---|---|
| Carbon black (specific surface area: 55 m/g²) | 100 parts |
| Alpha-alumina (average particle size: 0.15 μm) | 0.5 parts |
| Nitrocellulose (from Bergerac NC) | 75 parts |
| Polyether polyester polyurethane resin | 23 parts |
| (Mw: 50,000; —SO₃Na group content: 65 eq/ton) | |
| Methyl ethyl ketone | 900 parts |
| Toluene | 250 parts |

To the dispersion were added 1.0 part of polymer particles Y-1, and the mixture was dispersed in a bead mill using 0.5 mm diameter zirconia beads.

To the dispersion were further added 2 parts of a polyester resin (Vylon 500, from Toyobo) and 16 parts of polyisocyanate (Coronate L, from Nippon Polyurethane). The mixture was stirred in a commercially available stirrer and filtered through a filter with an average pore size of 1.0 μm to prepare coating composition I for backcoat layer.

### (6) Making of Magnetic Recording Medium

The coating composition for nonmagnetic layer was applied to a web of a nonmagnetic support (length: 10,000 m) to a dry thickness of 1.0 μm and dried at 110° C. in a known manner to form a nonmagnetic layer.

The coating composition for magnetic layer was applied to the nonmagnetic layer to a dry thickness of 0.04 μm by the method taught in JP 2003-236452A and dried at 120° C. to form a magnetic layer.

The coating composition I for backcoat layer was applied to the opposite side of the web to a dry thickness of 0.6 μm in a known manner and dried at 120° C. to form a backcoat layer.

The drying conditions of the nonmagnetic layer, the magnetic layer, and the backcoat layer were adjusted appropriately so that the total residual solvent content of these layers might be in the range of from 2 to 5 mg/g.

The coated web was calendered on a 7-roll calender having only metal rolls set at 100° C. under a linear pressure of 350 kg/cm at a speed of 80 m/min and wound on a core into roll form. The roll of the coated web was heat treated at 65° C. for 72 hours and then slit to ½ inch width to make a magnetic recording tape.

### (7) Evaluation

The resulting magnetic tape was examined and evaluated in terms state of degree of structure of polymer particles Y-1 in the backcoat layer, surface profile (a centerline average surface roughness Ra and the number of protrusions of 100 nm or higher) and surface resistivity of the backcoat layer, running properties of the tape, and total residual solvent content of the tape in the same manner as in Example 1-1. The magnetic tape was further evaluated in terms of indentation hardness on both sides, frequency of dropout, and the number of depressions on the magnetic layer in accordance with the methods described below. The results obtained are shown in Table 7.

### (a) Indentation Hardness

A nanoindentation tester ENT-1100 available from Elionix Inc. equipped with a three-sided pyramidal diamond nanoindenter (rake angle: 65°; apex angle: 115°) was used. The load was continuously increased up to 6 mgf (58.8 μN) on 10 seconds, held at 6 mgf for one second, followed by unloading on 10 seconds. The indentation hardness was calculated according to equation (1) given supra. The indentation hardness on each of the magnetic layer side and the backcoat layer side was measured at a measuring temperature of 5° C. and 50° C.

### (b) Frequency of Dropout

A 850 m length of the magnetic tape was wound onto a reel, put in a cartridge, and stored in an environment at 50° C. for one week. After the storage, the tape was recorded with signals at a linear recording density of 200 kfci over a length between 100 m and 200 m from the trailing end of the tape pack. The signals were read with an MR head having a read track width of 1.5 μm, and the number of dropouts per meter was counted, the dropout being defined as a 70% or more reduction in output. The frequency of the dropout occurrence was ranked as follows.

A: The frequency of dropout occurrence is less than 1 per meter.
B: The frequency of dropout occurrence is 1 or more and less than 3 per meter.
C: The frequency of dropout occurrence is 3 or more and less than 5 per meter,
D: The frequency of dropout occurrence is 5 or more and less than 10 per meter.
E: The frequency of dropout occurrence is 10 or more per meter.

### (c) Number of Depressions on Magnetic Layer

The tape used to determine the frequency of dropout was used for evaluation. The magnetic layer of the tape was examined by AFM using Nanoscope IV (from Digital Instruments) equipped with a four-sided pyramidal SIN probe having a tip angle of 70° over a total assessment area of 0.25 mm² (25×0.01 mm²) at a position 100 m from the trailing end of the tape pack. The number of depressions with a depth of 50 nm or more was counted.

As far as the magnetic recording medium prepared in Examples is concerned, since the magnetic layer defines the outermost surface of the medium, the surface condition of the surface side in terms of the number of the depressions is equivalent to that of the magnetic layer.

### Examples 3-2

### Preparation of Coating Composition II for Backcoat Layer

Coating composition II for backcoat layer was prepared in the same manner as for coating composition I of Example 3-1, except for changing the amounts of the nitrocellulose and the polyether polyester polyurethane resin (Mw: 50,000; —SO₃Na group content: 65 eq/ton) to 45 parts and 53 parts, respectively.

### Making and Evaluation of Magnetic Recording Medium:

A magnetic recording tape was made and evaluated in the same manner as in Example 3-1, except for using coating composition II in place of coating composition Ito make the backcoat layer.

### Example 3-3

### Preparation of Coating Composition III for Backcoat Layer

Coating composition III for backcoat layer was prepared in the same manner as for coating composition I, except for changing the amounts of the nitrocellulose and the polyether polyester polyurethane resin (Mw: 50,000; —SO₃Na group content: 65 eq/ton) to 30 parts and 68 parts, respectively.

### Making and Evaluation of Magnetic Recording Medium:

A magnetic recording tape was made and evaluated in the same manner as in Example 3-1, except for using coating composition III in place of coating composition I.

### Comparative Example 3-A

### Preparation of Coating Composition Iv for Backcoat Layer

Coating composition IV for backcoat layer was prepared in the same manner as for coating composition I, except for replacing polymer particles Y-1 with inorganic particles i (carbon black, specific surface area: 20 m²/g, see Table 6) forming aggregates of primary particles. The amount of inorganic particles i was adjusted so that the number of protrusions of 100 nm or higher on the backcoat layer might be approximately the same as that on the backcoat layer of Example 3-1.

### Making and Evaluation of Magnetic Recording Medium:

A magnetic recording tape was made and evaluated in the same manner as in Example 3-1, except for using coating composition IV to form the backcoat layer.

### Comparative Example 3-B

### Preparation of Polymer Particles Y-2

Polymer particles Y-2 (see Table 6) were prepared in the same manner as for polymer particles Y-1, except for omitting the pulverizing operation.

### Preparation of Coating Composition V for Backcoat Layer:

The components of formulation 12 below were mixed and dispersed in a known bead mill using 0.5 mm diameter zirconia beads.

### Formulation 12:

| | |
|---|---|
| Carbon black (specific surface area: 55 m/g²) | 100 parts |
| Alpha-alumina (average particle size: 0.15 μm) | 0.5 parts |
| Nitrocellulose (from Bergerac NC) | 75 parts |
| Polyether polyester polyurethane resin | 23 parts |
| (Mw: 50,000; —SO₃Na group content: 65 eq/ton) | |
| Methyl ethyl ketone | 900 parts |
| Toluene | 250 parts |

To the dispersion were added 1.0 part of polymer particles Y-2, 2 parts of a polyester resin (Vylon 500, from Toyobo), and 16 parts of polyisocyanate (Coronate L, from Nippon Polyurethane). The mixture was stirred in a commercially available stirrer and filtered through a filter with an average pore size of 1.0 μm to prepare coating composition V for backcoat layer.

### Making and Evaluation of Magnetic Recording Medium:

A magnetic recording tape was made and evaluated in the same manner as in Example 3-1, except for using coating composition V to form a backcoat layer.

### Example 3-4

### Preparation of Polymer Particles Z-1

A 5-liter reaction vessel was charged with 97 parts of styrene, 3 parts of methacrylic acid, 5 parts of t-dodecylmercaptan, 0.8 parts of sodium dodecylbenzenesulfonate, 0.4 parts of potassium persulfate, and 250 parts of water. The reaction system was heated to 80° C. while stirring in a nitrogen gas atmosphere to conduct polymerization over a period of 7 hours to make a seed polymer, which was found to have an average primary particle size D50 of 0.17 gm and a particle size distribution D25/D75 of 1.45. To 10 parts, on solid basis, of the seed polymer were added and mixed 1.2 parts of sodium laurylsulfate, 0.6 parts of potassium persulfate, 600 parts of water, and 125 parts of divinylbenzene (marketed product; purity: 55%, with the balance being monofunctional vinyl monomer), and the seed particles were allowed to adsorb the monomer while stirring at 30° C. for 15 minutes. The system temperature was raised to 80° C., at which polymerization was performed for 4 hours. The reaction system was filtered through a filter with an average pore size of 1.0 μm to remove foreign matter to obtain an aqueous dispersion of polymer particles.

The polymer particles were collected from the resulting aqueous dispersion using a known centrifugal separator. The polymer particles were re-dispersed in water by stirring and ultrasonication and then collected using a centrifugal separator. The re-dispersing and subsequent centrifugal separation were repeated three times to wash the polymer particles. The finally collected polymer particles were dried to remove water and pulverized using a known technique to give polymer particles having a crosslinked structure and forming no aggregates or agglomerates, designated Z-1 (see Table 6). Polymer particles Z-1 had an average primary particle size D50 of 0.32 μm and a size distribution D25/D75 of 1.55.

### Preparation of Coating Composition VI for Backcoat Layer:

Coating composition VI for backcoat layer was prepared in the same manner as for coating composition III, except for replacing polymer particles Y-1 with polymer particles Z-1. The amount of polymer particles Z-1 was adjusted so that the number of protrusions of 100 nm or higher on the backcoat layer might be approximately the same as that on the backcoat layer of Example 3-3.

### Making and Evaluation of Magnetic Recording Medium:

A magnetic recording tape was made and evaluated in the same manner as in Example 3-1, except for using coating composition VI to form the backcoat layer.

### Example 3-5

### Preparation of Polymer Particles Z-2

The aqueous dispersion of the polymer particles prepared in Example 3-4 was subjected to classification using a known classifier. The classified polymer particles were washed, dried, and pulverized in the same manner as in Example 3-4 to yield polymer particles Z-2 (see Table 6). Polymer particles Z-2 had an average primary particle size D50 of 0.31 μm and a size distribution D25/D75 of 1.25.

### Preparation of Coating Composition VII for Backcoat Layer:

Coating composition VII for backcoat layer was prepared in the same manner as for coating composition III, except for replacing polymer particles Y-1 with polymer particles Z-2. The amount of polymer particles Z-2 was adjusted so that the number of protrusions of 100 nm or higher on the backcoat layer might be approximately the same as that on the backcoat layer of Example 3-3.

### Making and Evaluation of Magnetic Recording Medium:

A magnetic recording tape was made and evaluated in the same manner as in Example 3-1, except for using coating composition VII to form the backcoat layer.

### Example 3-6

### Preparation of Nonmagnetic Support

A commercially available, 4.3 μm thick PEN film of continuous length was prepared. A vapor deposit mainly of nonmagnetic aluminum oxide was formed using a known vacuum evaporation system on one side of the film where a magnetic layer was to be provided to a deposit thickness of 80 nm and on the other side where a backcoat layer was to be provided to a deposit thickness of 100 nm. There was thus obtained a nonmagnetic support having a vapor deposit mainly of aluminum oxide on both sides thereof.

### Making and Evaluation of Magnetic Recording Medium:

A magnetic recording tape was made and evaluated in the same manner as in Example 3-1, except for using the support prepared above.

### Comparative Example 3-C

A magnetic recording tape was made and evaluated in the same manner as in Example 3-6, except for using coating composition IV to form the backcoat layer.

### Example 3-7

A magnetic recording tape was made and evaluated in the same manner as in Example 3-6, except for using coating composition II to form the backcoat layer.

### Example 3-8

A magnetic recording tape was made and evaluated in the same manner as in Example 3-6, except for using coating composition III to form the backcoat layer.

### Example 3-9

A magnetic recording tape was made and evaluated in the same manner as in Example 3-1, except for using a commercially available, 3.5 μm thick film made mainly of an aromatic polyamide (aramid) as a nonmagnetic support.

### Comparative Example 3-D

A magnetic recording tape was made and evaluated in the same manner as in Example 3-9, except for using coating composition IV to form the backcoat layer.

### Example 3-10

A magnetic recording tape was made and evaluated in the same manner as in Example 3-9, except for using coating composition II to form the backcoat layer.

### Example 3-11

A magnetic recording tape was made and evaluated in the same manner as in Example 3-9, except for using coating composition III to form the backcoat layer.

### Example 3-12

### Preparation of Coating Composition VIII for Backcoat Layer

Coating composition VIII for backcoat layer was prepared in the same manner as for coating composition I, except for replacing polymer particles Y-1 with inorganic particles j of the invention in which the primary particles formed no aggregates or agglomerates (see Table 6). The amount of inorganic particles j was adjusted so that the number of protrusions of 100 nm or higher on the backcoat layer might be approximately the same as that on the backcoat layer of Example 3-1.

### Making and Evaluation of Magnetic Recording Medium:

A magnetic recording tape was made and evaluated in the same manner as in Example 3-1, except for using coating composition VIII to form the backcoat layer.

### Example 3-13

### Preparation of Coating Composition IX for Backcoat Layer

Coating composition IX for backcoat layer was prepared in the same manner as for coating composition II, except for replacing polymer particles Y-1 with inorganic particles j. The amount of inorganic particles j was adjusted so that the number of protrusions of 100 nm or higher on the backcoat layer might be approximately the same as that on the backcoat layer of Example 3-2.

### Making and Evaluation of Magnetic Recording Medium:

A magnetic recording tape was made and evaluated in the same manner as in Example 3-1, except for using coating composition IX to form the backcoat layer.

### Example 3-14

### Preparation of Coating Composition X for Backcoat Layer

Coating composition X for backcoat layer was prepared in the same manner as for coating composition III, except for replacing polymer particles Y-1 with inorganic particles j. The amount of inorganic particles j was adjusted so that the number of protrusions of 100 mm or higher on the backcoat layer might be approximately the same as that on the backcoat layer of Example 3-3.

### Making and Evaluation of Magnetic Recording Medium:

A magnetic recording tape was made and evaluated in the same manner as in Example 3-1, except for using coating composition X to form the backcoat layer.

### Example 3-15

A magnetic recording tape was made and evaluated in the same manner as in Example 3-6, except for using coating composition VIII to form the backcoat layer

### Example 3-16

A magnetic recording tape was made and evaluated in the same manner as in Example 3-7, except for using coating composition IX to form the backcoat layer.

### Example 3-17

A magnetic recording tape was made and evaluated in the same manner as in Example 3-8, except for using coating composition X to form the backcoat layer.

### Example 3-18

A magnetic recording tape was made and evaluated in the same manner as in Example 3-9, except for using coating composition VIII to form the backcoat layer.

### Example 3-19

A magnetic recording tape was made and evaluated in the same manner as in Example 3-10, except for using coating composition IX to form the backcoat layer.

### Example 3-20

A magnetic recording tape was made and evaluated in the same manner as in Example 3-11, except for using coating composition X to form the backcoat layer.

TABLE 6

| | | | | | | | | Polyether |
|---|---|---|---|---|---|---|---|---|
| Coating | | | | | | | | Polyester |
| Composition | Particles | | | | | | Nitrocellulose | Polyurethane |
| No. | No. | Kind | Components | Shape | D50 (μm) | D25/D75 | (part) | (part) |
| I | Y-1 | crosslinked | divinylbenzene- | spherical | 0.31 | 1.03 | 75 | 23 |
| | | polymer | methacrylic acid- | (no aggregate) | | | | |
| | | particles | styrene copolymer | | | | | |
| II | Y-1 | crosslinked | divinylbenzene- | spherical | 0.31 | 1.03 | 45 | 53 |
| | | polymer | methacrylic acid- | (no aggregate) | | | | |
| | | particles | styrene copolymer | | | | | |
| III | Y-1 | crosslinked | divinylbenzene- | spherical | 0.31 | 1.03 | 30 | 68 |
| | | polymer | methacrylic acid- | (no aggregate) | | | | |
| | | particles | styrene copolymer | | | | | |
| IV | i | inorganic | carbon black | amorphous | — | — | 75 | 23 |
| | | particles | | (with aggregates) | | | | |
| V | Y-2 | crosslinked | divinylbenzene- | spherical | 0.31 | 1.03 | 75 | 23 |
| | | polymer | methacrylic acid- | (no aggregate) | | | | |
| | | particles | styrene copolymer | | | | | |
| VI | Z-1 | crosslinked | divinylbenzene- | spherical | 0.32 | 1.55 | 30 | 68 |
| | | polymer | methacrylic acid- | (no aggregate) | | | | |
| | | particles | styrene copolymer | | | | | |
| VII | Z-2 | crosslinked | divinylbenzene- | spherical | 0.31 | 1.25 | 30 | 68 |
| | | polymer | methacrylic acid- | (no aggregate) | | | | |
| | | particles | styrene copolymer | | | | | |
| VIII | j | inorganic | SiO₂ | spherical | 0.30 | 1.02 | 75 | 23 |
| | | particles | | (no aggregate) | | | | |
| IX | j | inorganic | ″ | spherical | 0.30 | 1.02 | 45 | 53 |
| | | particles | | (no aggregate) | | | | |
| X | j | inorganic | ″ | spherical | 0.30 | 1.02 | 30 | 68 |
| | | particles | | (no aggregate) | | | | |

TABLE 7

| | | | | | | Magnetic | Indentation Hardness | | | | | |
|---|---|---|---|---|---|---|---|---|---|---|---|---|
| | | Backcoat Layer | | | | Layer/ | (kg/mm) | | | | | |
| | | Coating | Degree | | Number of | Number of | Backcoat | | Magnetic | | | |
| | | Composition | of | | Protrusions | Depressions | Layer | | Layer | | Running | Dropout |
| | Support | No. | Structure | Ra (nm) | (/0.1 mm²) | (/0.25 mm²) | 5° C. | 50° C. | 5° C. | 50° C. | Properties | Frequency |
| Example 3-1 | PEN | I | A | 16.7 | 31 | 18 | 73 | 66 | 67 | 61 | A | D |
| Example 3-2 | ″ | II | A | 16.6 | 29 | 12 | 66 | 59 | 67 | 61 | A | C |
| Example 3-3 | ″ | III | A | 16.4 | 30 | 6 | 57 | 52 | 67 | 61 | A | B |
| Comp. Ex. 3-A | ″ | IV | C | 17.1 | 33 | 54 | 73 | 66 | 67 | 61 | A | E |
| Comp. Ex. 3-B | ″ | V | C | 16.6 | 32 | 30 | 73 | 66 | 67 | 61 | A | E |
| Example 3-4 | ″ | VI | A | 16.5 | 31 | 11 | 57 | 52 | 67 | 61 | A | C |
| Example 3-5 | ″ | VII | A | 16.4 | 30 | 8 | 57 | 52 | 67 | 62 | A | B |
| Example 3-6 | PEN | I | A | 16.8 | 32 | 8 | 73 | 66 | 67 | 61 | A | B |
| | with vapor | | | | | | | | | | | |
| | deposit | | | | | | | | | | | |
| Comp. Ex. 3-C | PEN | IV | C | 17.0 | 34 | 24 | 73 | 66 | 67 | 61 | B | E |
| | with vapor | | | | | | | | | | | |
| | deposit | | | | | | | | | | | |
| Example 3-7 | PEN | II | A | 16.7 | 31 | 5 | 66 | 59 | 67 | 61 | A | B |
| | with vapor | | | | | | | | | | | |
| | deposit | | | | | | | | | | | |
| Example 3-8 | PEN | III | A | 16.5 | 31 | 3 | 57 | 52 | 67 | 61 | A | A |
| | with vapor | | | | | | | | | | | |
| | deposit | | | | | | | | | | | |
| Example 3-9 | aramid | I | A | 16.4 | 30 | 12 | 74 | 67 | 68 | 62 | A | C |
| Comp. Ex. 3-D | ″ | IV | C | 16.8 | 32 | 37 | 74 | 67 | 68 | 62 | B | E |
| Example 3-10 | ″ | II | A | 16.3 | 31 | 8 | 67 | 60 | 68 | 62 | A | B |
| Example 3-11 | ″ | III | A | 16.2 | 30 | 4 | 58 | 53 | 68 | 62 | A | A |
| Example 3-12 | PEN | VIII | A | 16.5 | 33 | 20 | 73 | 66 | 67 | 61 | A | D |
| Example 3-13 | ″ | IX | A | 16.4 | 31 | 14 | 66 | 59 | 67 | 61 | A | D |
| Example 3-14 | ″ | X | A | 16.2 | 31 | 7 | 57 | 52 | 67 | 61 | A | B |
| Example 3-15 | PEN | VIII | A | 16.7 | 33 | 10 | 73 | 66 | 67 | 61 | A | C |
| | with vapor | | | | | | | | | | | |
| | deposit | | | | | | | | | | | |
| Example 3-16 | PEN | IX | A | 16.6 | 32 | 6 | 66 | 59 | 67 | 61 | A | B |
| | with vapor | | | | | | | | | | | |
| | deposit | | | | | | | | | | | |
| Example 3-17 | PEN | X | A | 16.4 | 31 | 4 | 57 | 52 | 67 | 61 | A | A |
| | with vapor | | | | | | | | | | | |
| | deposit | | | | | | | | | | | |
| Example 3-18 | aramid | VIII | A | 16.2 | 32 | 13 | 74 | 67 | 68 | 62 | A | D |
| Example 3-19 | ″ | IX | A | 16.1 | 32 | 9 | 67 | 60 | 68 | 62 | A | C |
| Example 3-20 | ″ | X | A | 16.0 | 31 | 5 | 58 | 53 | 68 | 62 | A | B |

In all of Examples 3-1 through 3-20 and Comparative Examples 3-A to 3-D, the surface resistivity of the backcoat layer was equal (ranging from 5×10⁵ to 7×10⁵ Ω/sq), and the total residual solvent content was equal (ranging from 2 to 5 mg/g).

Examples 3-1 through 1-11 provided magnetic recording tapes exhibiting good running properties and reduced dropout errors.

Although the tapes of Comparative Examples 3-A and 3-B exhibited good running properties, they suffered from increased occurrence of dropout. This increase in dropout frequency is believed to be because the particles existed in the form of aggregates or agglomerates in the backcoat layer to form large protrusions that were imprinted on the magnetic layer to form depressions causing dropouts.

Comparing Examples 3-1, 3-2, and 3-3, the frequency of dropout descended in that order. This is believed to be because the pressure exerted by the protrusions on the backcoat layer to the magnetic layer reduces as the backcoat layer surface becomes softer, resulting in the formation of less depressions on the magnetic layer surface.

The reason the frequency of dropout errors in Example 3-4 was somewhat higher than in Example 3-3 is considered to be that the particles used in the former had a larger particle size distribution D25/D75 and therefore formed more protrusions that were imprinted to the magnetic layer to cause dropouts.

In Example 3-5 in which the particles used in Example 3-4 were classified to have a reduced particle size distribution D25/D75, the occurrence of dropouts reduced compared with Example 3-4. Thus, reducing particle size distribution D25/D75 by classification proved effective to reduce dropout occurrence.

Frequency of dropout in Examples 3-6 to 3-8 and 3-9 to 3-11 was lower than in Examples 3-1 to 3-3. This is ascribable to the fact that the support with a deposit and the aramid support are less liable to allow the magnetic layer to form depressions causing dropout during storage in a high temperature environment than a PEN support. It has now been proved that using a support with a deposit or an aramid support is effective to reduce dropout. In Comparative Examples 3-C and 3-D in which a conventional formulation (coating composition IV) was used to form a backcoat layer, using a support with a deposit or an aramid support was not so effective as to reduce the depressions causing dropout to a level suited for use in high density recording.

Furthermore, the running properties of the tapes of Comparative Examples 3-C and 3-D having the support with a deposit and the aramid support, respectively, are not good enough, whereas Examples 3-6 to 3-11 demonstrate the effect of the support with a deposit and the aramid support in improving the running properties. These results indicate that the backcoat layer according to the invention provides more excellent running properties than the conventional formulation (coating composition IV) when used in combination with a support with a deposit or an aramid support.

A support with a deposit and an aramid support exhibit good dimensional stability against reversible dimensional changes and have therefore been proposed for use in magnetic recording media used in various environments. When used along with the backcoat layer of the invention, they are very effective in producing a high density recording medium with reduced dropout occurrence as well as improved running properties.

The same effects of the support with a deposit and the aramid support are observed in Examples 3-12 through 3-20 in which inorganic particles j were used, providing magnetic recording tapes with reduced dropout occurrence, Nevertheless, the frequencies of dropout in Examples 3-12 to 3-20 are somewhat higher than those in Examples 3-1 to 3-11. This demonstrates that the polymer particles Y-1 are more effective than the inorganic particles j in reducing dropout occurrence.

The magnetic recording medium of the invention exhibits not only good running stability but excellent electromagnetic characteristics by virtue of reduced depressions on the magnetic layer, the depression being formed by back imprinting and causing a dropout, an increased error rate, and reduction in S/N.

What is claimed is:

1. A magnetic recording medium comprising, in the following order:
a backcoat layer;
a nonmagnetic support;
a nonmagnetic layer comprising a nonmagnetic powder and a binder; and
a magnetic layer comprising a ferromagnetic powder and a binder,
wherein the backcoat layer comprises particles having an average primary particle size D50 of from 0.05 to 1.0 μm and forming substantially no aggregates nor agglomerates in the backcoat layer.

2. The magnetic recording medium according to claim 1, wherein the particles have an average primary particle size D50 of from 0.1 to 0.6 μm.

3. The magnetic recording medium according to claim 1, wherein the particles are spherical particles having a particle size distribution D25/D75 of 2.0 or smaller.

4. The magnetic recording medium according to claim 3, wherein the particle size distribution D25/D75 is 1.5 or smaller.

5. The magnetic recording medium according to claim 3, wherein the particles have the particle size distribution D25/D75 adjusted to 2.0 or smaller by classification.

6. The magnetic recording medium according to claim 1, wherein the particles are polymer particles having a crosslinked structure.

7. The magnetic recording medium according to claim 1, wherein the particles are polymer particles comprising at least one component selected from the group consisting of an acrylic compound, styrene, divinylbenzene, benzoguanamine, melamine, formaldehyde, butadiene, acrylonitrile, and chloroprene.

8. The magnetic recording medium according to claim 1, wherein the particles are thermoplastic and have a glass transition temperature or a softening temperature of from 20° to 160° C.

9. The magnetic recording medium according to claim 1, wherein the particles are polymer particles obtained by seed emulsion polymerization in which a crosslinkable or polymerizable monomer is added to an aqueous dispersion of seed particles, adsorbed by the seed particles, and allowed to polymerize.

10. The magnetic recording medium according to claim 1, wherein the particles are inorganic particles mainly comprising silicon dioxide.

11. The magnetic recording medium according to claim 1, wherein the backcoat layer is free from carbon black having a specific surface area less than 30 m²/g.

12. The magnetic recording medium according to claim 1, wherein the magnetic layer, the nonmagnetic layer, and the backcoat layer have a total residual solvent content of from 0.1 to 25 mg/g.

13. The magnetic recording medium according to claim 1, having a lower indentation hardness on a side of the backcoat layer than on a side of the magnetic layer.

14. The magnetic recording medium according to claim 1, wherein the nonmagnetic support is one of a support mainly comprising an aromatic polyamide and a support having a nonmagnetic layer of a metal or a metallic inorganic compound formed on at least one side thereof by vapor deposition.
